(19) United States
(12) Patent Application Publication
(10) Pub. No.: US 2026/0008064 A1
(43) Pub. Date: Jan. 8, 2026

(54) HIGH SPEED CLARIFICATION OF A LIQUID SUSPENSION

(71) Applicants: FIBERLITE CENTRIFUGE LLC, Santa Clara, CA (US); THERMO ELECTRON LED S.A.S., Saint Herblain (FR)

(72) Inventors: Sina PIRAMOON, Santa Clara, CA (US); Benoit Jean LIMON, Courtaboeuf (FR)

(21) Appl. No.: 18/879,970

(22) PCT Filed: Jun. 27, 2023
(86) PCT No.: PCT/EP2023/067531

§ 371 Date: Dec. 30, 2024

Related U.S. Application Data
(60) Provisional application No. 63/367,331, filed on Jun. 30, 2022.

(51) Int. Cl. B04B 5/04; B04B 7/02; B04B 7/12

(52) U.S. Cl. CPC B04B 5/0428; B04B 7/12; B04B 2005/0435; B04B 2007/025

(57) ABSTRACT

Systems and methods of clarifying a liquid suspension at high speeds contained in a flexible bag is provided. The method includes nesting at least one flexible bag containing the liquid suspension within at least one bag adapter with the at least one inlet line and/or outlet line extending from the flexible bag to an exterior of the bag adapter. The method further includes at least partially enclosing the at least one inlet line and/or outlet line within a crown cavity defined by a crown assembly. The method further includes centrifuging the at least one bag adapter and the at least one flexible bag containing the liquid suspension in a centrifuge to produce a super-natant fluid and a pellet in the at least one flexible bag.

### FIELD OF THE INVENTION

The present invention relates to methods and systems for separating species suspended in a liquid suspension. Particularly, the present invention is related to bioprocessing methods and systems for clarifying biological suspensions having species suspended therein.

### BACKGROUND OF THE INVENTION

Centrifuges are used in laboratories to separate mixtures of substances into their constituents using centrifugal force. In many applications, the mixtures of substances are biological or microbiological liquid suspensions. One example is cell suspensions, which may come from fermentation tanks, bioreactors, or similar containers, for example, and which are to be at least partially divided into their constituents by centrifugation.

Previous methods have used relatively low-speed centrifugation in an attempt to separate large-sized cell debris and particle contaminants, such as 1-10 micron-sized particles, from liquid suspensions, such as culture media or other biological suspensions. However, low-speed centrifugation has been shown to be insufficient to render the liquid suspension sufficiently free of such particles for some production purposes, such as products that require the separation and/or removal of particles sized less than or equal to 1 micron.

Accordingly, a need exists for further clarifying liquid suspensions to remove more cell debris and particle contaminants suspended in a culture media beyond the levels capable of low-speed centrifugation, as well as a need to develop suitable equipment to accomplish such clarification.

### SUMMARY OF THE INVENTION

According to the present invention, a method and system for clarifying a culture media is provided.

In particular, in an embodiment, a bag adapter configured to enclose a flexible bag containing a liquid suspension and having at least one inlet line and/or outlet line fluidly coupled to the flexible bag, with the at least one inlet and/or outlet line extending from the flexible bag to an exterior of the bag adapter is provided. The bag adapter includes a lower bag receptacle portion configured to receive a lower portion of the flexible bag. The lower bag receptacle portion includes a bottom wall and a circumferential lower side wall extending upwardly from the bottom wall and defining, with the bottom wall, a lower bag cavity having an opening located opposite the bottom wall and defined by a rim of the circumferential lower side wall, the lower bag receptacle portion at least partially enclosing the lower portion of the flexible bag when the lower portion of the flexible bag is received in the lower bag receptacle portion through the opening of the lower bag cavity. The bag adapter further includes an upper closure portion configured to be joined to the lower bag receptacle portion and receive an upper portion of the flexible bag. The upper closure portion includes a top wall and a circumferential upper side wall depending from the top wall and defining, with the top wall, an upper bag cavity having an opening located opposite the top wall and defined by a rim of the upper side wall, the upper closure portion at least partially enclosing the upper portion of the flexible bag when the upper portion of the flexible bag is received through the opening of the upper bag cavity. The bag adapter further includes at least one aperture formed in the upper closure portion providing at least one passageway extending between the upper bag cavity and an exterior of the upper closure portion. The at least one passageway is configured so that the at least one inlet line and/or outlet line may extend through the at least one passageway from the upper bag cavity to the exterior of the upper closure portion. The bag adapter encloses the flexible bag when the lower bag receptacle portion and the upper closure portion are joined together.

In a related embodiment, the bag adapter includes at least a pair of apertures.

In a related embodiment, the lower bag receptacle portion and the upper closure portion define an overlap joint at a juncture of the lower bag receptacle portion and the upper closure portion.

In a related embodiment, the bottom wall of the lower bag receptacle portion includes a rounded shoulder that joins the circumferential lower side wall of the lower bag receptacle portion.

In a related embodiment, the top wall of the upper closure portion includes a rounded shoulder that joins the circumferential upper side wall of the upper closure portion.

In a related embodiment, the at least one aperture is formed in the rounded shoulder of the upper closure portion.

In a related embodiment, a pair of apertures is formed in the rounded shoulder of the upper closure portion.

In a related embodiment, the circumferential lower side wall of the lower bag receptacle portion is circular in transverse cross section.

In a related embodiment, the circumferential upper side wall of the upper closure portion is circular in transverse cross section.

In a related embodiment, the upper closure portion is releasably joined to the lower bag receptacle portion.

Furthermore, a crown assembly for use with a rotor to at least partially enclose at least one inlet line and/or outlet line fluidly coupled to at least one flexible bag containing a liquid suspension during centrifugation of the at least one flexible bag in the rotor is provided. The crown assembly includes an annular crown body defining a crown cavity. The crown cavity includes a bottom wall, a circumferential side wall spaced upwardly from the bottom wall, and a circumferential scalloped side wall extending between the bottom wall and the circumferential side wall. The circumferential scalloped side wall includes a plurality of radially inwardly directed arcuate walls disposed circumferentially about the circumferential scalloped side wall. The annular crown body furthermore includes at least one aperture formed in each of the plurality of radially inwardly directed arcuate walls providing at least one passageway extending between an exterior of the annular crown body and the crown cavity. The at least one passageway is configured so that the at least one inlet line and/or outlet line may extend through the at least one passageway from the exterior of the annular crown body to the crown cavity. The annular crown body furthermore includes an annular mount extending upwardly from the bottom wall and being disposed centrally within the annular crown body. The crown assembly furthermore includes a resilient element supported by the annular mount. The crown assembly furthermore includes a crown assembly plunger operatively engaging the resilient element and being moveable vertically relative to the annular mount between first and second positions. The resilient element biases the crown assembly plunger to the first position, and the crown assembly plunger is movable to the second position in response to compression of the resilient element by a lid of the rotor. The crown assembly furthermore includes an annular crown ring removably joined to the annular crown body and being configured, with the annular crown body, to at least partially enclose the at least one inlet line and/or outlet line fluidly connected to the flexible bag within the crown cavity during centrifugation of the at least one flexible bag in the rotor.

In a related embodiment, the annular crown ring includes an annular side wall and an annular lip extending radially inwardly from the annular side wall of the annular crown ring.

In a related embodiment, the annular lip extends radially inwardly and downwardly from the annular side wall of the annular crown ring.

In a related embodiment, the annular lip is at least partially translucent.

In a related embodiment, the annular crown ring is mounted in the crown cavity.

In a related embodiment, the crown assembly further includes at least one O-ring supported by the annular side wall of the annular crown ring and being configured to engage the circumferential side wall of the annular crown body when the annular crown ring is mounted in the crown cavity.

In a related embodiment, the crown assembly may further include a carbon fiber reinforcement disposed about the annular side wall of the annular crown ring.

In a related embodiment, the at least one aperture includes a pair of apertures.

In a related embodiment, the annular mount includes an inner annular wall extending upwardly from the bottom wall and an outer annular wall extending upwardly from the bottom wall and being disposed concentrically about the inner annular wall to define a cavity between the inner and outer annular walls of the annular mount. The cavity of the annular mount is configured to support the resilient element at least partially within the cavity of the annular mount.

In a related embodiment, the crown assembly plunger includes an annular body defining an annular shoulder, an inner annular wall depending from the annular shoulder, and an outer annular wall depending from the annular shoulder and being disposed concentrically about the inner annual wall to define a cavity between the inner and outer annular walls of the crown assembly plunger. The cavity of the crown assembly plunger is configured to support the resilient element at least partially within the cavity of the crown assembly plunger.

In a related embodiment, the crown assembly plunger is mounted for movement at least partially within the annular mount.

In a related embodiment, the plurality of radially inwardly directed arcuate walls comprises four arcuate walls.

In a related embodiment, the plurality of radially inwardly directed arcuate walls comprises at least six arcuate walls.

Furthermore, a kit is provided. The kit includes at least one bag adapter configured to enclose a flexible bag containing a liquid suspension and having at least one inlet line and/or outlet line fluidly coupled to the flexible bag, with the at least one inlet and/or outlet line extending from the flexible bag to an exterior of the bag adapter. The at least one bag adapter includes a lower bag receptacle portion configured to receive a lower portion of the flexible bag. The lower bag receptacle portion includes a bottom wall and a circumferential lower side wall extending upwardly from the bottom wall and defining, with the bottom wall, a lower bag cavity having an opening located opposite the bottom wall and defined by a rim of the lower side wall, the lower bag receptacle portion at least partially enclosing the lower portion of the flexible bag when the lower portion of the flexible bag is received in the lower bag receptacle portion through the opening of the lower bag cavity. The bag adapter further includes an upper closure portion configured to be joined to the lower bag receptacle portion and receive an upper portion of the flexible bag. The upper closure portion includes a top wall, a circumferential upper side wall depending from the top wall and defining, with the top wall. The upper closure portion further includes an upper bag cavity having an opening located opposite the top wall and defined by a rim of the upper side wall, the upper closure portion at least partially enclosing the upper portion of the flexible bag when the upper portion of the flexible bag is received through the opening of the upper bag cavity. The upper closure portion further includes at least one aperture formed in the upper closure portion providing at least one passageway extending between the upper bag cavity and an exterior of the upper closure portion. The at least one passageway is configured so that the at least one inlet line and/or outlet line extends through the at least one passageway from the upper bag cavity to the exterior of the upper closure portion, with the bag adapter enclosing the flexible bag when the lower bag receptacle portion and the upper closure portion are joined together. The kit further includes the crown assembly previously described.

In a related embodiment, the kit further includes at least one flexible bag configured to contain a liquid suspension and having at least one inlet line and/or outlet line fluidly coupled to the flexible bag.

Furthermore, a method of clarifying a liquid suspension contained in a flexible bag is provided. The method includes nesting the at least one flexible bag containing the liquid suspension within at least one bag adapter with the at least one inlet line and/or outlet line extending from the flexible bag to an exterior of the bag adapter. The method further includes at least partially enclosing the at least one inlet line and/or outlet line within a crown cavity defined by a crown assembly. The method further includes centrifuging the at least one bag adapter and the at least one flexible bag containing the liquid suspension in a centrifuge to produce a supernatant fluid and a pellet in the at least one flexible bag.

In a related embodiment, the method includes the step of extracting the supernatant fluid from the at least one flexible bag via at least one outlet line fluidly coupled to the at least one flexible bag.

In a related embodiment, the method includes at least one flexible bag is removed from the at least one bag adapter prior to the extraction step.

In a related embodiment, the method further includes receiving the liquid suspension in the at least one flexible bag via at least one inlet line.

In a related embodiment, the method includes the at least one flexible bag is located at least partially outside of the at least one bag adapeter when the liquid suspension is received in the at least one flexible bag.

In a related embodiment, the method includes the liquid suspension is received in the at least one flexible bag via the at least one inlet line which is fluidly coupled to a source of liquid suspension.

In a related embodiment, the method further includes an inlet manifold fluidly coupled to the source of liquid suspension and to the at least one inlet line fluidly coupled to the at least one flexible bag.

In a related embodiment, the bag adapter used in the method includes a lower bag receptacle portion configured to enclose a lower portion of the flexible bag and an upper closure portion configured to enclose an upper portion of the flexible bag, the bag adapter being configured to withstand greater g-forces than the at least one flexible bag.

In a related embodiment, the method is performed in a closed system.

In a related embodiment, the method includes the supernatant fluid is extracted into in an outlet manifold via the at least one outlet line which is fluidly coupled to the flexible bag containing the liquid suspension.

In a related embodiment, the method includes centrifuging the bag adapter at a rate of greater than or equal to 5,000 rotations per minute.

In a related embodiment, the method includes applying a force of above 7,000 g to the bag adapter.

In a related embodiment, the method includes the supernatant fluid being extracted into a storage container.

In a related embodiment, the method includes extracting the supernatant fluid into an outlet manifold.

In a related embodiment, the method includes receiving the liquid suspension in the at least one flexible bag via at least one inlet line when a bottom portion of the flexible bag is enclosed in a lower bag receptacle portion of the bag adapter.

### BRIEF DESCRIPTION OF THE DRAWINGS

Exemplifying embodiments of the present invention and their advantages are explained in greater detail below in the sense of an example and with reference to the accompanying figures, where:

FIG. 1 is a disassembled view of an exemplary system for clarifying a liquid suspension;

FIG. 2A is a cross sectional view of an assembled system for clarifying a liquid suspension with a crown plunger in a first position;

FIG. 2B is a cross sectional view of an assembled system for clarifying a liquid suspension with a crown plunger in a second position;

FIG. 3 is a perspective view of a crown assembly;

FIG. 4 is another perspective view of a crown assembly;

FIG. 5 is a disassembled view of a crown assembly;

FIG. 6 is a cross sectional view of a crown assembly;

FIG. 7 is a perspective view of an assembled bag adapter including a flexible bag enclosed therein;

FIG. 8 is a disassembled view of a bag adapter including a flexible bag to be enclosed therein;

FIG. 9 is a cross sectional view of a bag adapter including a flexible bag enclosed therein;

FIG. 10A is a flowchart of a method of clarifying a liquid suspension;

FIG. 10B is a flowchart of a related method of clarifying a liquid suspension;

FIG. 10C is a flowchart of a related method of clarifying a liquid suspension;

FIG. 11A is system view of flexible bags having partially received a liquid suspension therein in a receiving step of a method;

FIG. 11B is a system view of flexible bags having received a liquid suspension therein in a receiving step of a method;

FIG. 11C is a system view of weighing flexible bags;

FIG. 11D is a view of a flexible bag receiving a liquid suspension;

FIG. 11E is a view of an inlet line being severed from a flexible bag with a welding machine;

FIG. 11F is a view of a cap being placed on a folded-end of a severed inlet line

FIG. 11G is a view of an assembled bag adapter having a flexible bag therein filled with a liquid suspension;

FIG. 11H is a disassembled view of system for centrifuging a liquid suspension including a centrifuge rotor, a crown assembly, and bag adapters enclosing flexible bags filled with the liquid suspension;

FIG. 11I is an assembled view of the system for centrifuging the liquid suspension shown in FIG. 11H;

FIG. 11J is a partial cross sectional view of the system shown FIG. 11I after centrifugation of the liquid suspension forms a pellet and a supernatant fluid;

FIG. 11K is system view of flexible bags having undergone centrifugation, the bags including supernatant fluid to be removed from the flexible bags; and

FIG. 11L is system view of flexible bags having undergone centrifugation, the bags having had some of the supernatant fluid removed from the flexible bags and stored in a storage container.

### DETAILED DESCRIPTION OF THE INVENTION

It is understood that all ranges of parameters described herein include the endpoints of the given range. Furthermore, all sub-ranges of each given range are contemplated as suitable embodiments of the invention described herein.

A system and method have been developed in order to clarify and/or pelletize and remove cell debris or particle contaminants suspended in a liquid suspension from a supernatant obtained from a cell collection process. In some examples, the cell collection process includes a harvest step, a lysis step, a cell generation step, or any combination of these. These steps are explained in more detail below. In some embodiments, the system 100 may include a centrifuge rotor 400, a crown assembly 200, at least one flexible bag 350, and at least one bag adapter 300.

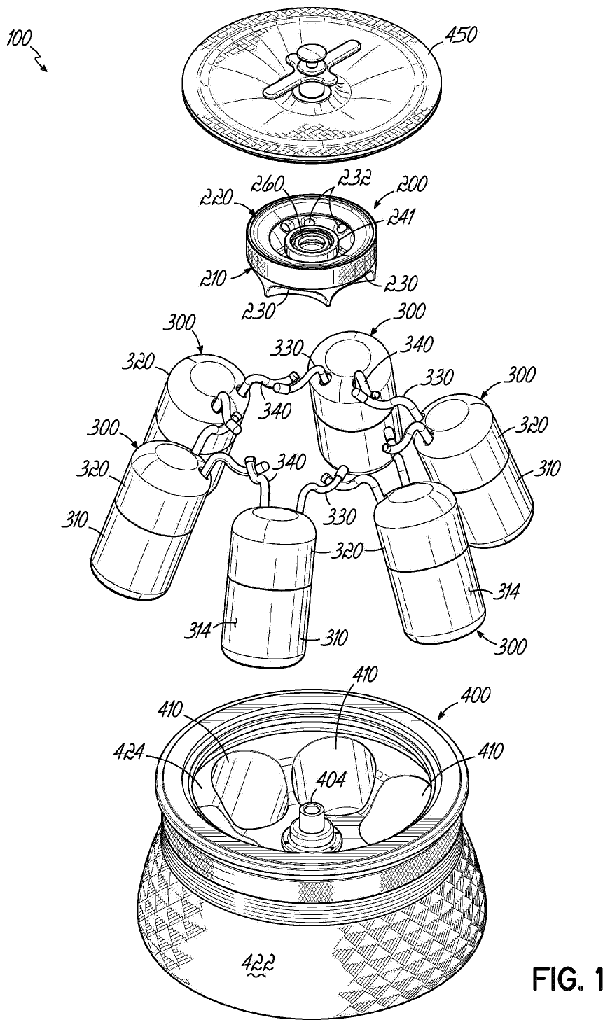

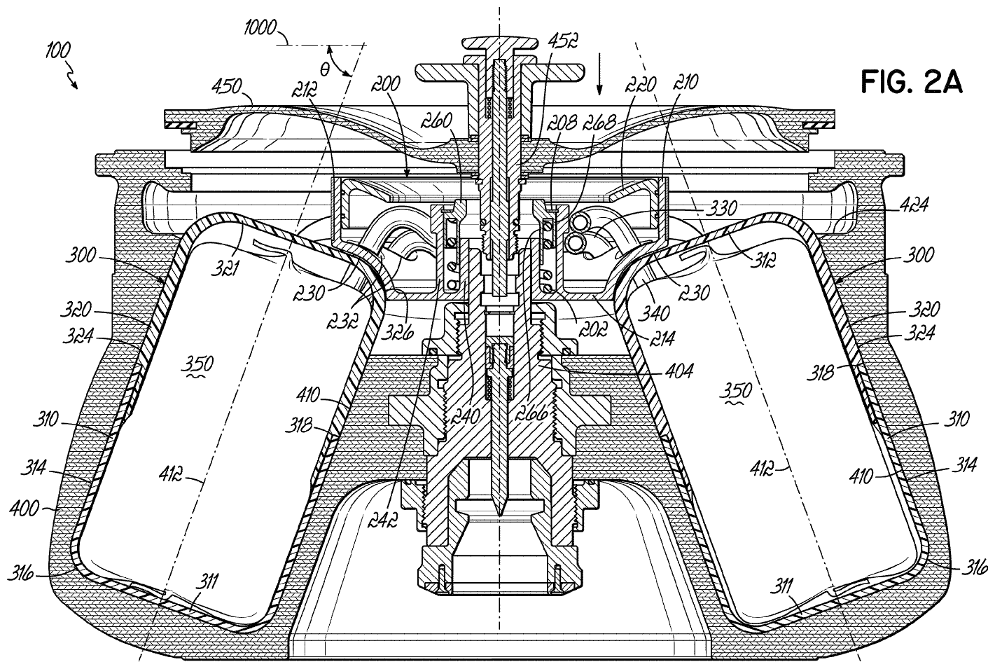

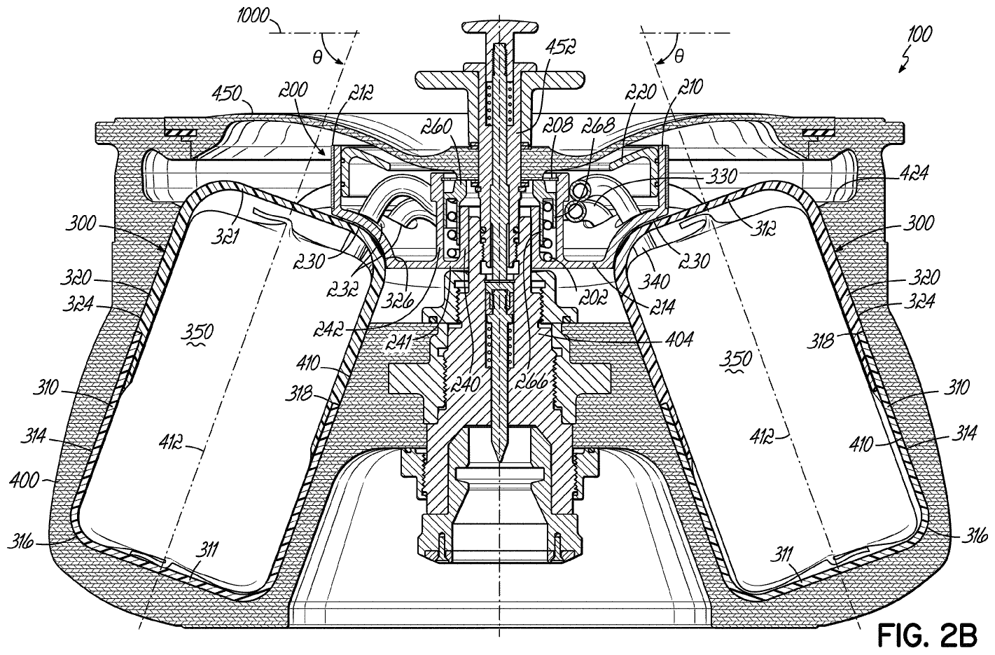

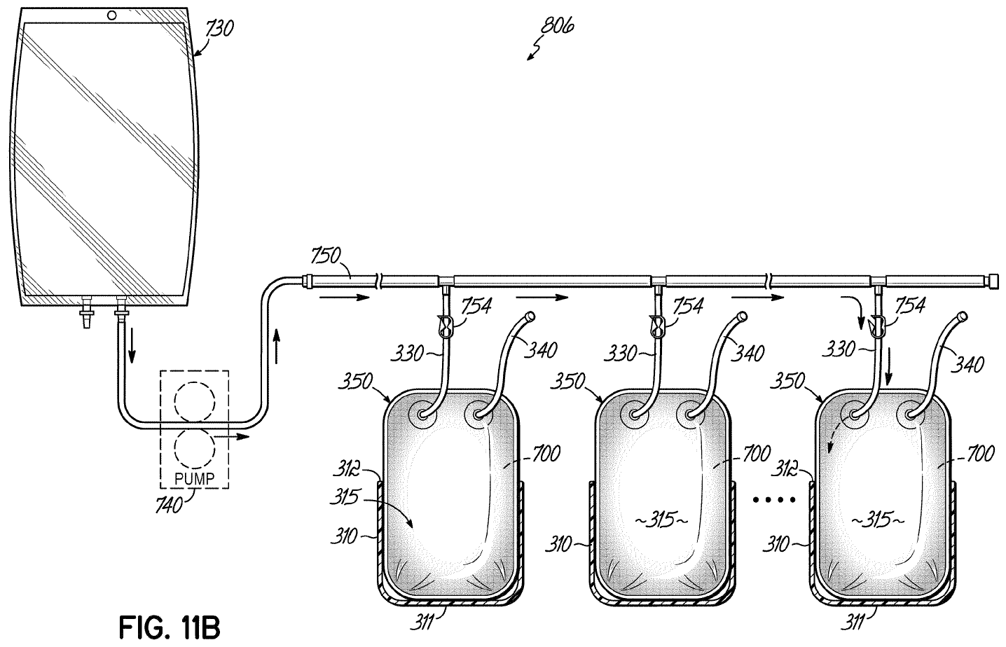

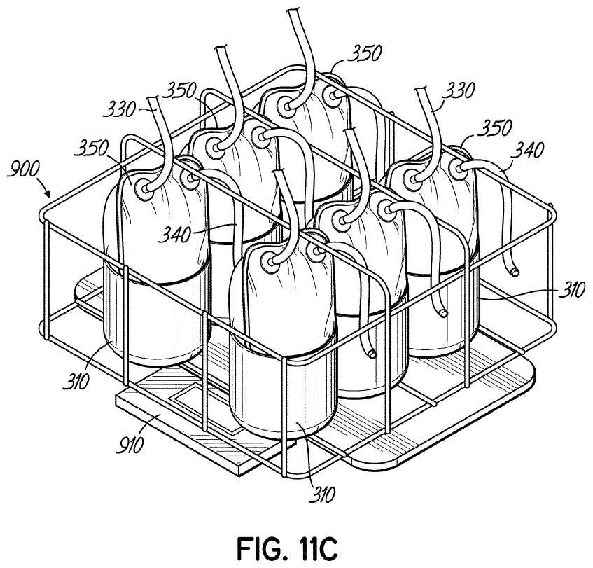

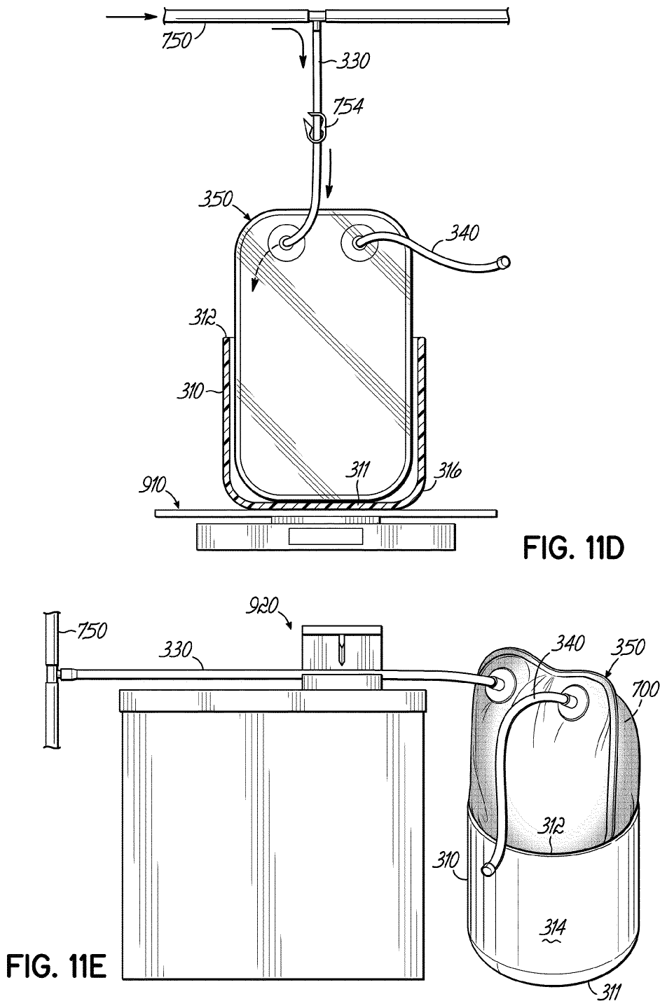

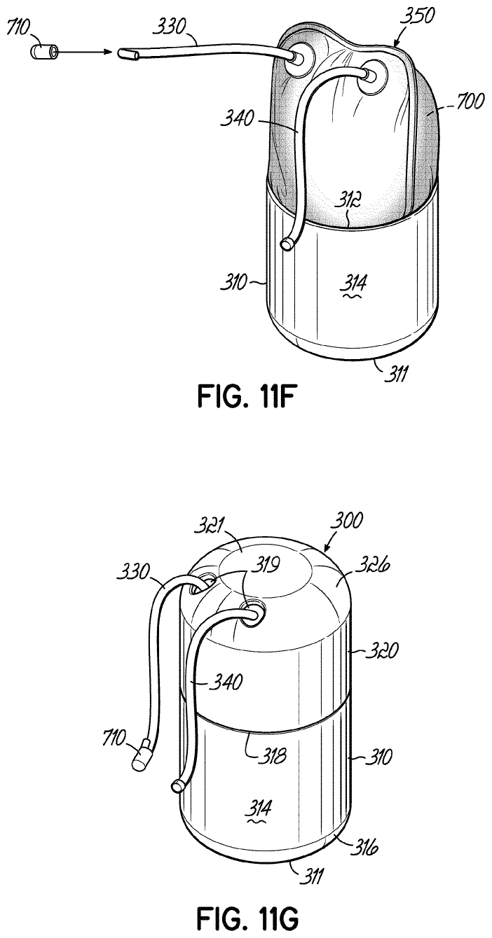

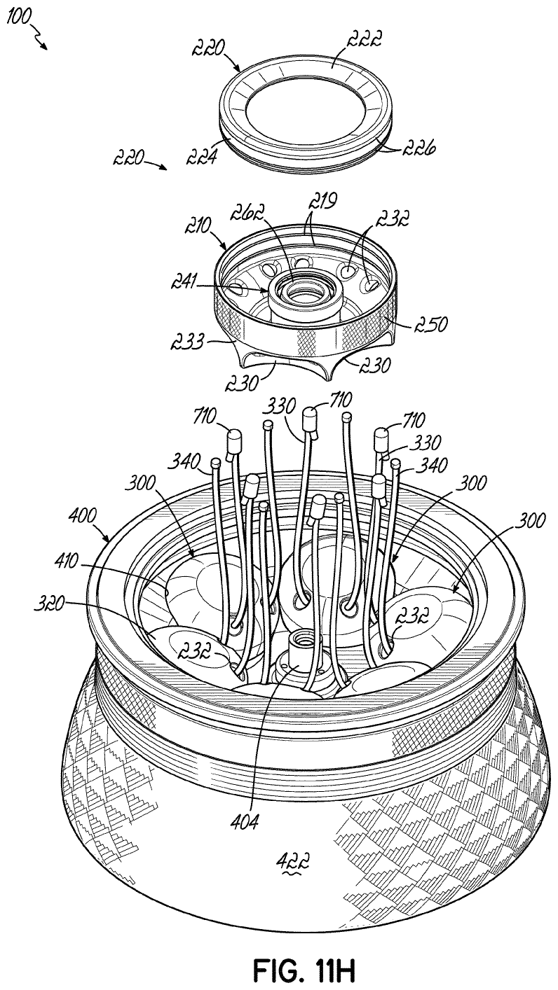

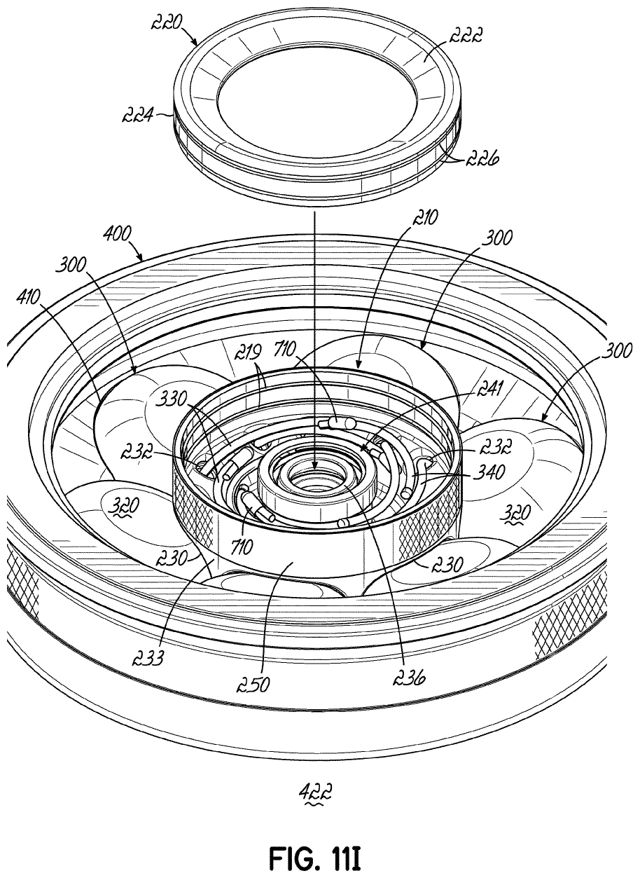

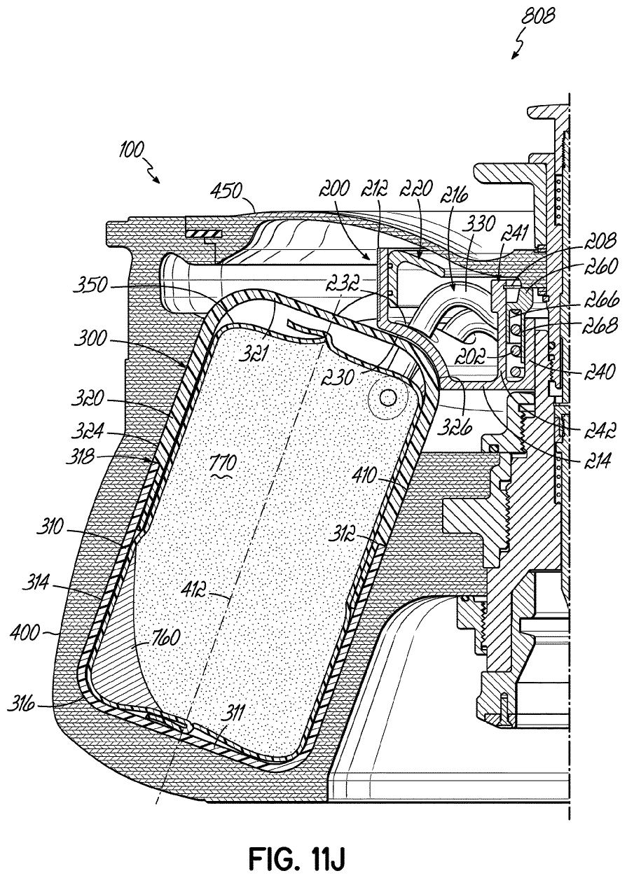

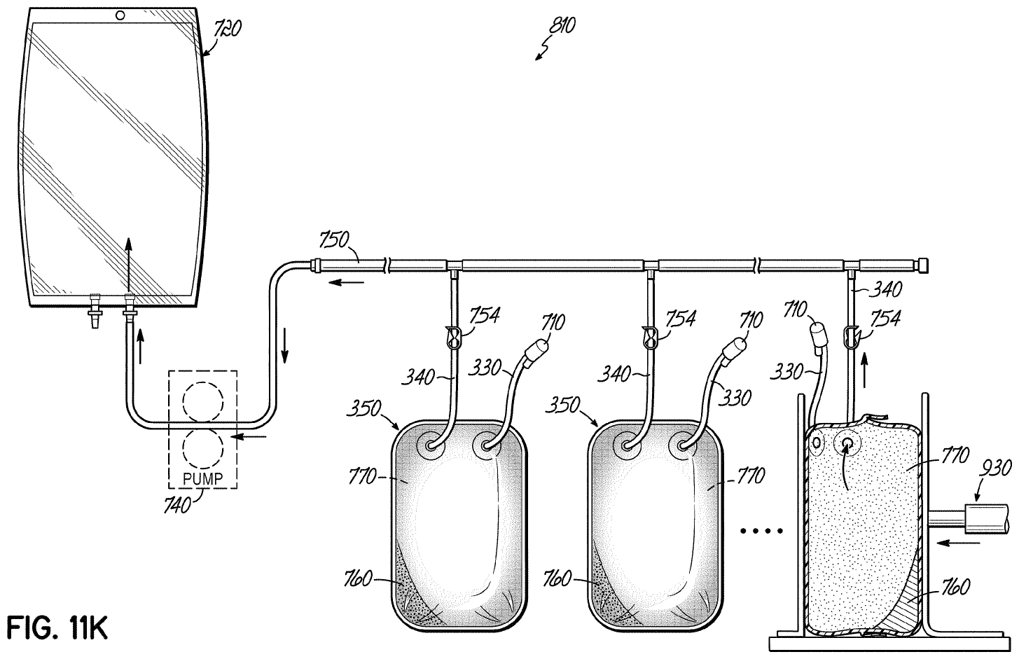

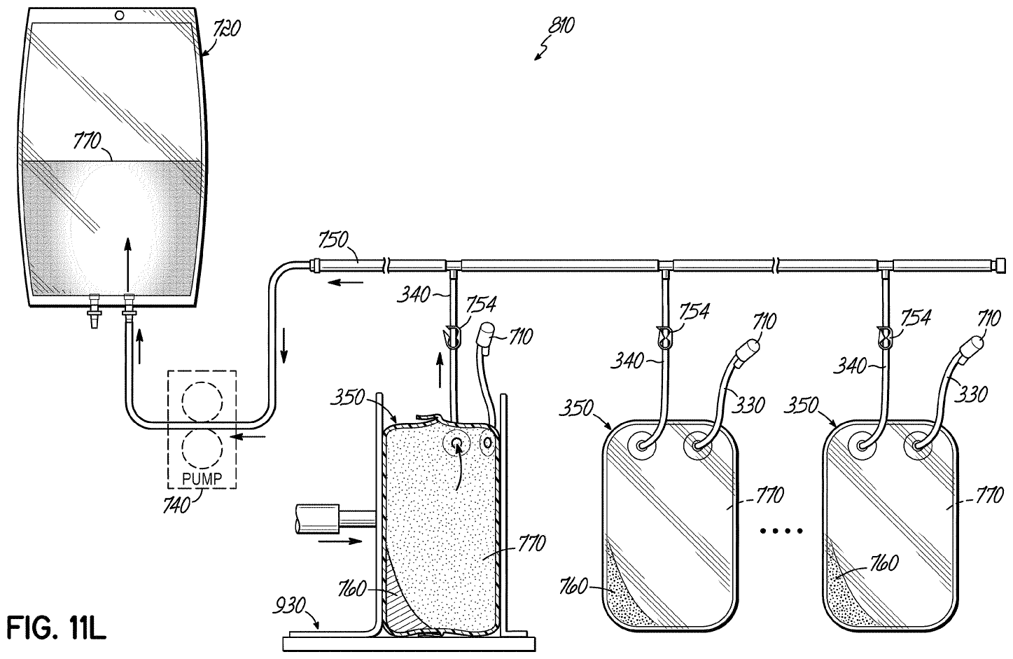

Referring to FIG. 1, a disassembled view of a system 100 for clarifying a liquid suspension 700 (shown in for example FIGS. 11A and 11B) is shown. The system 100 includes at least the centrifuge rotor 400 including a rotor body 424, and a lid 450, the crown assembly 200, multiple bag adapters 300, and multiple flexible bags 350 (shown in FIGS. 2A and 2B, not shown in FIG. 1, but is housed within the bag adapter 300).

A centrifuge is a device that is configured to rotate liquid suspensions, such as liquid suspension 700, balanced therein at high rotational speeds resulting in separation of substances suspended in the liquid suspension 700. In some instances, centrifugation of the liquid suspension 700 may result in pelletizing solids suspended within the liquid suspension 700 into a pellet 760 (shown in FIGS. 11J-11L) and a supernatant fluid 770, separate from the pellet 760, substantially free of the solids previously suspended in the liquid suspension 700. In an embodiment of the invention, cell debris and particle contaminants are suspended in the liquid suspension 700 prior to centrifugation. The centrifuge rotor 400 located in a body of the centrifuge (not shown) may be a fixed angle rotor and may be configured to rotate liquid suspensions 700 placed within receptacles or cavities 410 located on the centrifuge rotor 400. A crown locator 404 is located in a center of the centrifuge rotor 400 and, in some embodiments, is configured to connect with a motor (not shown) of the centrifuge to spin the centrifuge rotor 400. In an embodiment, the rotor body 422 has a top surface 424 that slopes radially outward and upward from the crown locator 404. Recessed into the rotor body 422 from the top surface 424 are a plurality of radially-spaced receptacles or cavities 410. Each receptacle 410 is sized to receive a flexible bag 350, and more specifically a bag adapter 300, and may be generally cylindrical in shape, or any other shape such that the shape of the receptacle 410 conforms to the shape of the bag adapter 300. That is, each receptacle 410 is configured to receive, in a complementary fit, an individual bag adapter 300, which may include a flexible bag 350 filled with a liquid suspension, so as to reduce stress on the flexible bags 350 during centrifugation.

In order to keep the liquid suspensions 700 from haphazardly moving within the centrifuge rotor 400 during operation, and to ensure a sterile environment preventing contaminants from interacting with the liquid suspensions 700, the liquid suspensions 700 are placed in the multiple flexible bags 350 (shown in FIGS. 2A and 2B). As described above, the centrifuge rotor 400 includes any number of receptacles 410 for the flexible bags 350, specifically when housed within the bag adapters 300, to be placed therein. In an embodiment, the centrifuge rotor 400 includes between 2 and 10 receptacles 410. In a preferred embodiment, the centrifuge rotor 400 includes between 4 and 6 receptacles 410. In another embodiment, the centrifuge rotor 400 includes at least 4 receptacles 410. In another embodiment, the centrifuge rotor 400 includes at least 6 receptacles 410. Examples of particularly suitable centrifuges configured to accept the centrifuge rotor 400 are commercially available from Fiberlite Centrifuge LLC. Of Santa Clara, CA and include the models LYNX® 6000 or LYNX® 4000. Examples of suitable centrifuge rotors 400 for use in the present invention include the models F9-6x1000 LEX and/or F10-4x1000 LEX, commercially available from Thermo Fisher Scientific Inc. of Waltham, MA.

During operation of the centrifuge rotor 400 during centrifugation, the flexible bag 350 may be insufficient or incapable of maintaining its integrity due to high g-forces that would ordinarily be exerted on the flexible bag 350. To assist the flexible bag 350 withstanding the g-forces exerted thereon during operation of the centrifuge rotor 400 during centrifugation, the flexible bag 350 may be placed in the bag adapter 300. The bag adapter 300 is sized to be received in the receptacles 410 of the centrifuge rotor 400. As described herein, the centrifuge rotor 400 may operate at rotational speeds of between 500 and 10,500 rotations per minute (rpm). In a preferred embodiment, and to promote the clarification of relatively small cell debris and particle contaminants, such as cell debris and particle contaminants sized less than or equal to 1 micron, from the liquid suspension 700, the centrifuge rotor 400 may operate at rotational speeds of greater than or equal to 5,000 rpm, such as between 5,000 and 10,500 rpm, preferably between 6,000 and 10,500 rpm, and more preferably between 8,000 and 10,500 rpm. Furthermore, these high rotational speeds may result in high g-forces being exerted on the liquid suspension 700, the flexible bag 350, and/or the bag adapter 300. These g-forces may amount to greater than or equal to 7,000 times the force of gravity, such as between 7,000 and 21,000 times the force of gravity. In a preferred embodiment, the g-forces amount to between 9,000 and 21,000 times the force of gravity, and more preferably between 15,000 and 20,584 times the force of gravity. At such high rotational speeds and g-force applications, clarification may be achieved, however, at some high speeds, the bag adapter 300 may be included to house the flexible bag 350 to ensure that the flexible bag 350 does not fail. At least due to the high operating speeds of the centrifuge rotor 400, contaminants such as cell debris or cells, may be pelletized, forming a pellet 760, from the liquid suspension 700.

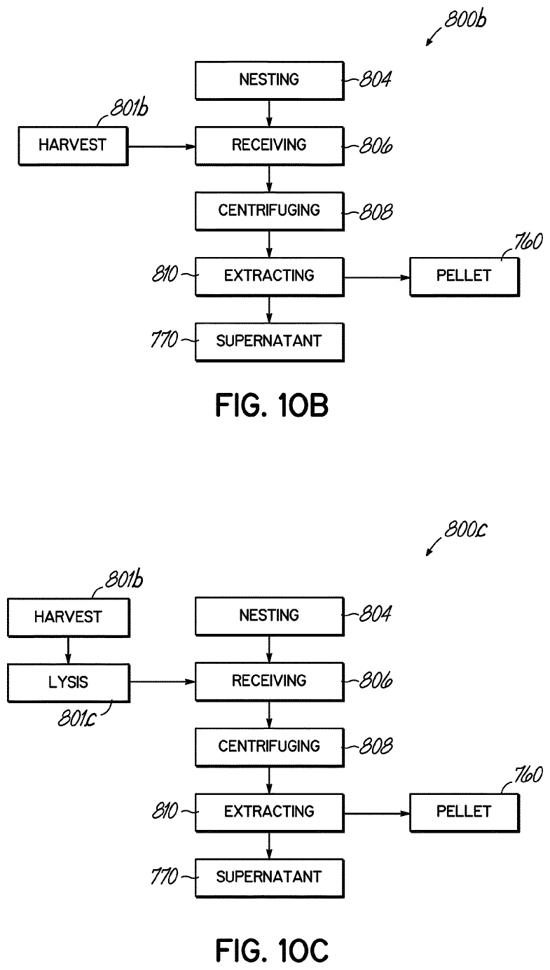

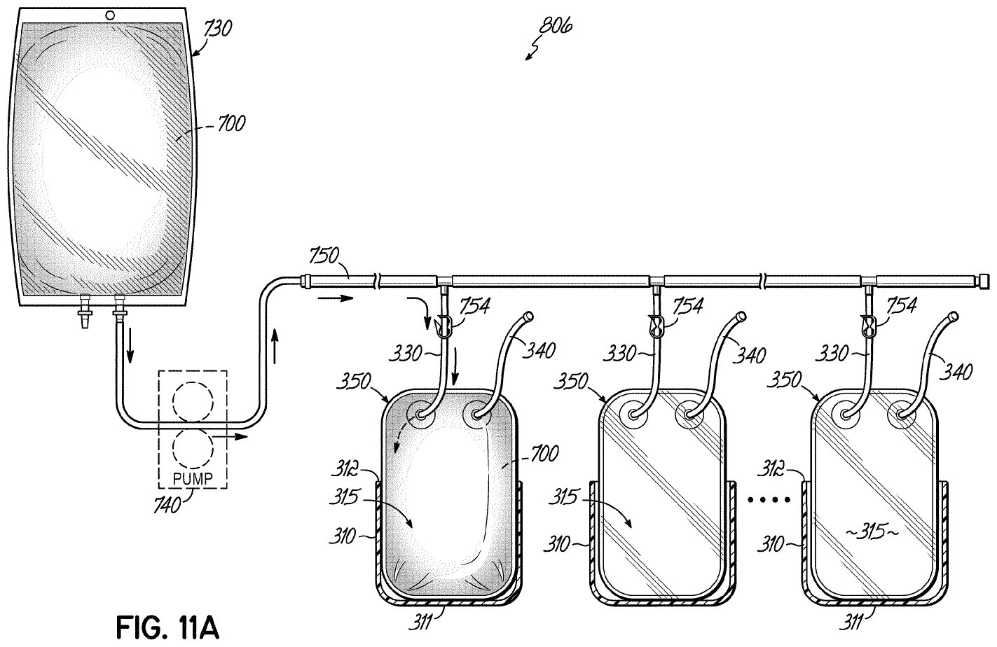

In some embodiments, a harvest step 801C (shown in FIG. 10) occurs prior to centrifuging the liquid suspension 700. As described below, a liquid phase used in the harvest step 801C may include contaminants therein, and may be pelletized in the harvest step 801C. The contaminants included in the liquid suspension 700 may be sized differently than contaminants pelletized in the harvest step 801C. Alternatively or in addition, the harvest step 801C may be insufficient to pelletize some contaminants, regardless of their size. In such a case, the contaminants pelletized during the clarification process may be similarly sized to the contaminants pelletized in the harvest step 801C. The harvest step 801C is described in more detail below.

FIG. 1 shows six bag adapters 300 and corresponding receptacles 410 in the centrifuge rotor 400, however any number of bag adapters 300 may be used up to a maximum of the number of receptacles 410 included in the centrifuge rotor 400. The receptacles 410 of the centrifuge rotor 400 may be sized to receive the flexible bags 350. Alternatively or in addition, the receptacles 410 of the centrifuge rotor 400 may be sized to receive bag adapters 300 including the flexible bags 350 therein. The centrifuge rotor 400 shown in FIG. 1 is a fixed-angle centrifuge rotor. That is, the receptacles 410 of the centrifuge rotor 400 are disposed at the same orientation during the rotation of the centrifuge rotor 400. Each receptacle 410 may include a central axis 412 oriented at various fixed angles relative to a horizontal plane 1000 (shown in FIG. 2), for example at an angle ⊖ of between 30° to 60°, or at an angle ⊖ of between 30° to 45° degrees. Other angles ⊖ may also be used. As a result, the pellet formed by the centrifuging the liquid suspension 700 is typically formed off-center from the floor of the flexible bag 350. The lid 450 is coupled with the crown locator 404 and rotor body 422, and is used to cover the receptacles 410.

Accordingly the bag adapters 300 situated within the receptacles 410 are also covered during rotation of the centrifuge rotor 400 as described in greater detail below.

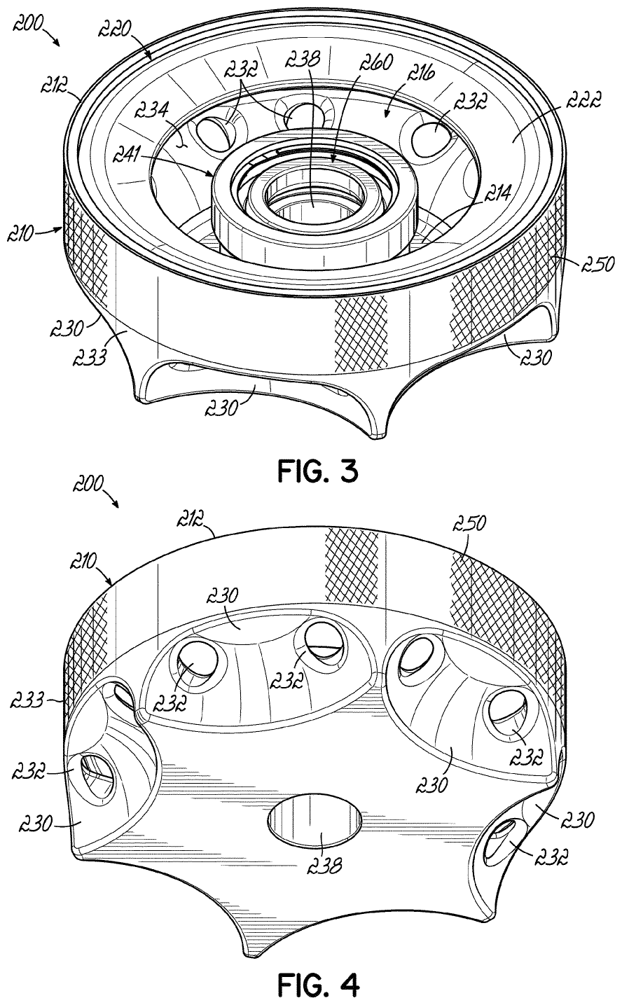

With continued reference to FIG. 1, a crown assembly 200 as well as bag adapters 300 are shown. These will be described in more detail below when referring to FIGS. 3-6 for the crown assembly 200, and FIGS. 7-9 for the bag adapter 300.

FIG. 2A shows a cross sectional view of an assembled centrifuge rotor 400 including liquid suspensions 700 to be centrifuged. Specific components shown in FIG. 2A are described in more detail below and are shown clearly in other figures. However, FIG. 2A shows the lid 450 positioned adjacent the centrifuge rotor 400. A locking mechanism 452 projects from the lid 450 into the crown assembly 200 and further into the centrifuge rotor 400. At least when the lid 450 is secured on the centrifuge rotor 400 (shown in FIG. 2B), the a central portion of the lid 450 meets a crown assembly plunger 260. In some embodiments, the crown assembly plunger 260 includes an annular body 262 defining an annular shoulder 264. The crown assembly plunger 260 may further include an inner annular wall 266 depending from the annular shoulder 264 and an outer annular wall 268 depending from the annular shoulder 264 and being disposed concentrically about the inner annual wall 266 to define a cavity 244 between the inner annular wall 266 and outer annular wall 268 of the crown assembly plunger 260, with the cavity 203 of the crown assembly plunger 260 being configured to support a resilient element 202 at least partially within the cavity 203 of the crown assembly plunger 260.

The crown assembly plunger 260 is movable within the crown assembly 200 from a first position (shown in FIG. 2A) to a second position (shown in FIG. 2B), where the crown assembly plunger's 260 first position is further from the bottom wall 214 and the second position is spaced closer to the bottom wall 214 than the first position. Furthermore, the crown assembly plunger 260 may be mounted for movement at least partially within an annular mount 241. The resilient element 202 is located within the crown assembly and biases the crown assembly plunger 260 toward the first position (i.e. away from the bottom wall 214 and the meeting of the crown assembly plunger 260 and the lid 450.) The meeting of the crown assembly plunger 260 and the lid 450 forms a seal 206, assisted by an Annular retaining ring 204. FIG. 2A shows the crown assembly plunger 260 in the first position, further from the bottom wall 214 than the second position (shown in FIG. 2B), and the resilient element 202 extended, biasing the crown assembly plunger 260 away from the bottom wall 214. In contrast, FIG. 2B shows the crown assembly plunger 260 in the second position, closer to the bottom wall 214 than the crown assembly plunger 260 in the first position, and the resilient element 202 compressed, biasing the crown assembly plunger 260 toward the lid 450. The crown assembly plunger 260 operatively engages the resilient element 202 and is moveable vertically relative to the annular mount 241 between first and second positions. The resilient element 202 biases the crown assembly plunger 260 to the first position. The crown assembly plunger 260 may be movable to the second position in response to compression of the resilient element 202 by a lid 450 of the rotor 400. The annular mount 241 includes an inner annular wall 240 extending upwardly from the bottom wall 214 of the crown assembly 200 and an outer annular wall 242 extending upwardly from the bottom wall 214 and being disposed concentrically about the inner annular wall 240 to at least partially define the cavity 244 between the inner annular wall 240 and outer annular wall 242 of the annular mount 241, with the cavity 244 of the annular mount 241 being configured to support the resilient element 202 at least partially within the cavity 244 of the annular mount 241. The annular mount 241 extends upwardly from the bottom wall 214 and is disposed centrally within the annular crown body 210.

FIGS. 3 and 4 show perspective views of an embodiment of the crown assembly. In some embodiments, the crown assembly 200 is made of a metal, in particular aluminum or steel, in an example spring steel, or a plastic. The crown assembly 200 includes an annular crown body 210 having an upper end face, or rim 212, and a lower end face, or bottom wall 214, the bottom wall 214 being opposite the rim 212, and the annular crown body 210 defining an interior crown space, or crown cavity 216. A removable annular lip, or annular crown ring 220, extends radially inward from a perimeter of the rim 212. The annular crown ring 220 may be removably joined to the annular crown body 210 and be configured, with the annular crown body 210, to at least partially enclose the at least one inlet line 330 and/or outlet line 340 (shown in FIG. 11I) fluidly connected to the flexible bag 350 so as to be located within the crown cavity 216 during centrifugation of the at least one flexible bag 350 in the rotor 400. The annular crown ring 220 may include an annular side wall 224 and an annular lip 222 extending radially inwardly from the annular side wall 224 of the annular crown ring 220. The annular lip 222 may be aligned with or disposed at an angle relative to a plane that includes the rim 212.

Particularly, in some examples, the annular lip 222 may be angled downward from the plane including the rim 212 at an angle of 5 degrees or greater. Alternatively or in addition, the annular lip 222 may be angled downward from the plane including the rim 212 at an angle of 10 degrees or greater.

In some embodiments, the annular crown ring 220 further includes an annular side wall 224 which joins the annular lip 222 at an angle. The crown assembly 200 may further include at least one O-ring 219 supported by the annular side wall 224 of the annular crown ring 220. The O-ring 219 may be configured to engage a circumferential side wall 233 of the annular crown body 210 when the annular crown ring 220 is mounted in the crown cavity 216. For example, the annular side wall 224 may include an annular side wall exterior surface 228 having O-ring receptacles 226. The O-ring receptacles 226 are sized to receive and maintain O-rings 219. The annular crown ring 220 may maintain the inlet lines 330 and outlet lines 340 within the crown cavity 216 of the annular crown body 210 during centrifugation, as described below. In some examples, the annular crown ring 220 is a component separate from the annular crown body 210, and may be coupled to the annular crown body 210 via frictional engagement of the O-rings 219 and/or the side wall 224 with the circumferential side wall 223 of the annular crown body 210. This coupling of the crown ring 220 with the annular crownbody 210 may result in a fixed or removeable coupling of the annular crown ring 220 to the annular crown body 210. In some embodiments, the annular crown ring 220 is at least translucent to allow a user to view through the annular crown ring 220 when examining the centrifuge rotor 400 contents without removing the annular crown ring 220. Alternatively or in addition, the annular crown ring 220 is transparent for similar reasons. Advantageously, the annular crown ring 220 may include 3-D printed materials, in whole or in part. Accordingly, it is conceived that the annular crown ring 220 may be formed from 3-D printing methods such as SLA (Stereolithography).

The annular crown body 210 furthermore includes the circumferential side wall 233 spaced upwardly from the bottom wall 214. The annular crown body 210 further includes a circumferential scalloped side wall 234 extending between the bottom wall 214 and the circumferential side wall 233. The circumferential scalloped side wall 234 includes a plurality of radially inwardly directed arcuate walls 230 disposed circumferentially about the circumferential scalloped side wall 234. Furthermore, the annular crown body 210 may include one or more apertures 232 formed in each of the plurality of radially inwardly directed arcuate walls 230. The apertures 232 provide at least one passageway extending between an exterior of the annular crown body 210 and the crown cavity 216. The at least one passageway is configured so that the at least one inlet line 330 and/or outlet line 340 (shown in FIG. 11I) may extend through the at least one passageway from the exterior of the annular crown body 210 to the crown cavity 216. In an embodiment, the apertures 232 included in each arcuate wall 230 are a pair of apertures 232. The arcuate walls 230 may be shaped to conform to a shape of at least a portion of the bag adapter 300 (shown in FIG. 2), and the apertures 232 are sized to receive inlet lines 330 and outlet lines 340 coupled to and extending from the flexible bag 350 which may be placed within the bag adapter 300. During operation of the centrifuge rotor 400, the inlet lines 330 and outlet lines 340 are positioned within the apertures 232 and extend further into the crown cavity 216 of the annular crown body 210. At least due to the annular crown ring 210 and the circumferential side wall 233 at least partially defining the crown cavity 216 of the annular crown body 210, the inlet lines 330 and outlines lines 340 do not flail haphazardly during operation of the centrifuge rotor 400. In some examples, caps 710 (shown in FIG. 11F and 11G) may be placed on folded-over ends of the inlet lines 330 and/or outlet lines 340 in any combination (shown in FIG. 11F, and described below). The caps 710 may prevent the inlet line 330 or outlet line 340 from unfolding during centrifugation, which may detrimentally allow the liquid suspension 700 to escape from the flexible bag 350. When a bag adapter 300 is loaded into a receptacle 410 of the centrifuge rotor 400, the annular crown body 210 is placed such that the arcuate walls 230 contact the bag adapter 300, for example at an exterior bag adapter surface as shown in FIGS. 2, 11H, and 11I), and prevent or inhibit unintended movement of the bag adapter 300 or flexible bag 350 during centrifugation.

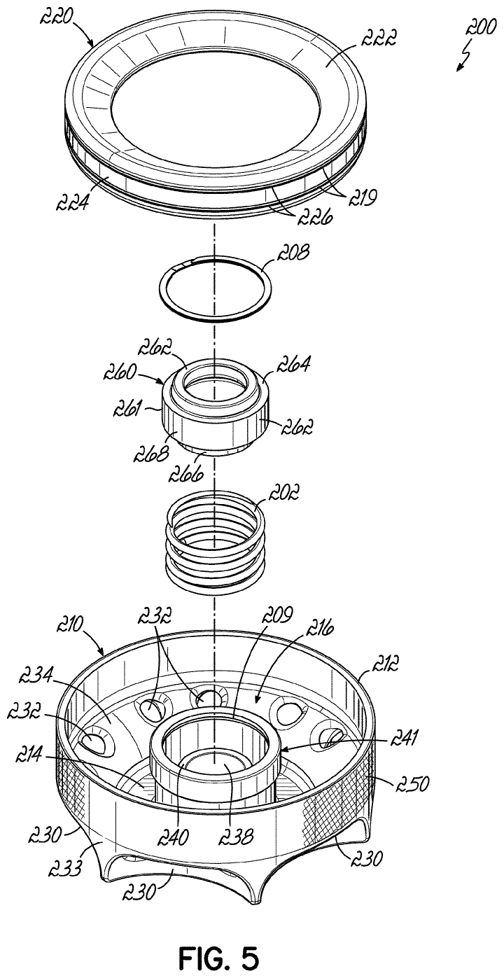

FIG. 5 is a disassembled view of the crown assembly 200. The disassembled view shows the annular crown body 210, the resilient element 202, the crown assembly plunger 260, an annular retaining ring 204, and the annular crown ring 220. Together, these components form the crown assembly 220 as described herein.

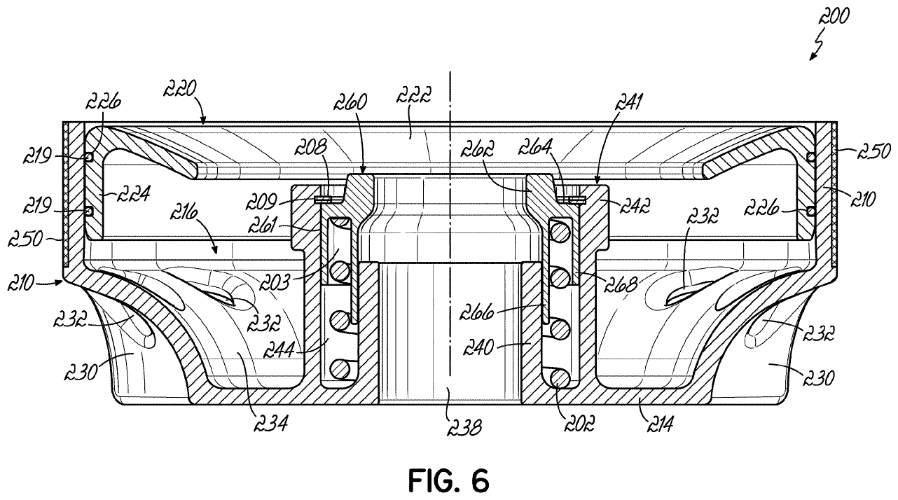

With reference to FIG. 6, a cross-section of the crown assembly 200 is shown. Particularly visible in FIG. 6 is a central aperture 238 through the annular crown body 210. The central aperture 238 is a passageway extending from the bottom wall 214 into the crown cavity 216 of the annular crown body 210. The central aperture 238 is defined by the inner annular wall 240 of the annular mount 241. With continued reference to FIG. 6, the annular retaining ring 204 is an annular structure positioned adjacent to the crown assembly plunger 260 and may include an outer perimeter 205 that extends beyond an outer perimeter 261 of the crown assembly plunger 260. The annular retaining ring 204 may be a resilient metal ring. As the resilient element 202 applies a bias to the crown assembly plunger 260 engages the retaining ring 204 which limits further vertical travel or extension of the crown assembly plunger 260 reltated to the annular mount 241. When the centrifuge is ready for operation (as shown in FIG. 2B), the annular retaining ring 204 is pressed against the locking mechanism to form a seal 206.

With continued reference to FIG. 6, a carbon fiber reinforcement 250 is shown disposed about the circumferential side wall 233 around an outer circumference of the annular crown body 210. Alternatively, or in addition, the carbon fiber reinforcement may be disposed about the annular side wall 224 of the annular crown ring 220. The carbon fiber reinforcement 250 may be, for example, a carbon fiber filament. The filament may be a composite material of carbon fiber and resin that may be cured in order to bind the filament to the annular crown body 210.

Alternatively, various other high-tensile, high-modulus materials, such as glass fiber, synthetic fiber such as para-aramid fiber (i.e., Kevlar®), thermoplastic filament, metal wire, or other materials suitable for reinforcing the annular crown body 210 may be used instead of carbon fiber. The carbon fiber reinforcement 250 may be bound to the annular crown body 210 chemically, for example by a cured resin, or physically, for example if there exists sufficient tension within the carbon fiber reinforcement 250 such that normal forces exerted upon the carbon fiber reinforcement 250 by the annular crown body 210 substantially eliminate slipping of the carbon fiber reinforcement 250 relative to the outer surface of the annular crown body 210.

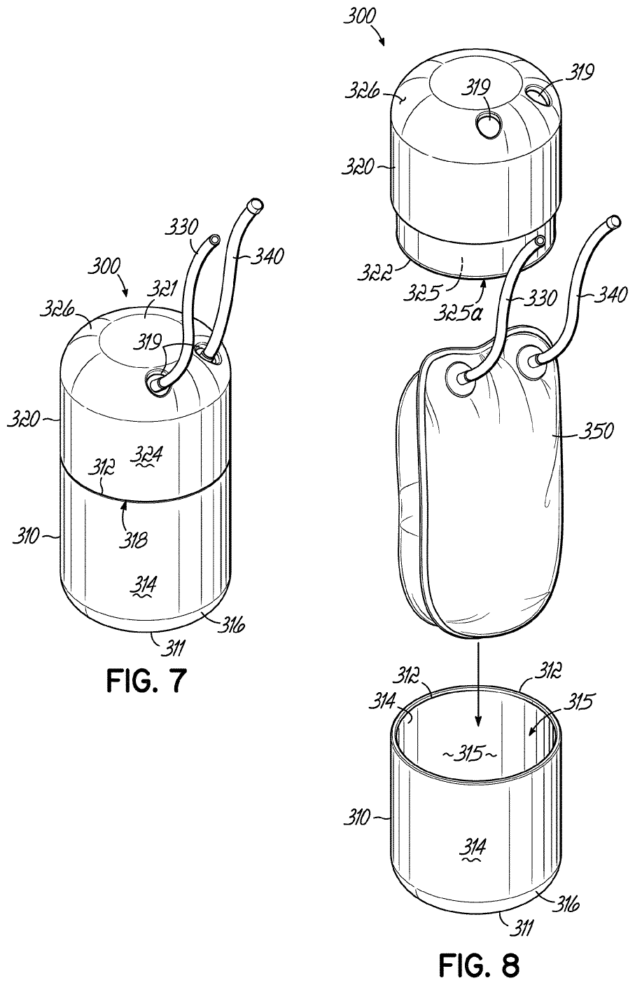

With reference to FIG. 7, the bag adapter 300 is shown in an assembled view along with a flexible bag 350 nested therein. The assembled bag adapter 300 includes a lower bag receptacle portion 310 and an upper closure portion 320. FIG. 7 further shows an inlet line 330 and an outlet line 340, which are coupled to the flexible bag 350 (shown in FIG. 8). Though the inlet line 330 is identified as the line in the foreground in FIG. 7 and the outlet line 340 is identified as the line in the background in FIG. 7, this is merely an illustrative example. It is contemplated that either the inlet line 330 or the outlet line 340 may, in practice, operate as line for the liquid suspension 700 to be received into the flexible bag 350 or a line to extract the supernatant fluid 770 after centrifugation from the flexible bag 350.

With reference to FIG. 8, a disassembled view of the bag adapter 300 and the flexible bag 350 is shown. The lower bag receptacle portion 310 includes a bottom wall 311 and a circumferential lower side wall 314 extending upwardly from the bottom wall 311 and defining, with the bottom wall 311, a lower bag cavity 315 having an opening 315a located opposite the bottom wall 311. The opening 315a is defined by a rim 312 of the circumferential lower side wall 314. The lower bag receptacle portion 310 at least partially encloses a lower portion 352 of the flexible bag 350 when the lower portion 352 of the flexible bag 350 is received in the lower bag receptacle portion 310 through the opening 315a of the lower bag cavity 315. In an embodiment, the bottom wall 311 of the lower bag receptacle portion 310 includes a rounded shoulder 316 that joins the circumferential lower side wall 314 of the lower bag receptacle portion 310. In an embodiment, the circumferential lower side wall 314 of the lower bag receptacle portion 310 is circular in transverse cross section.

The upper closure portion 320 is configured to be joined to the lower bag receptacle portion 310 and receive an upper portion 354 of the flexible bag 350. The upper closure portion 320 includes a top wall 321 and a circumferential upper side wall 324 depending from the top wall 321 and defining, with the top wall 321, an upper bag cavity 325 having an opening 325a located opposite the top wall 321 and defined by a rim 322 of the upper side wall 324, the upper closure portion 320 at least partially enclosing the upper portion 354 of the flexible bag 350 when the upper portion 354 of the flexible bag 350 is received through the opening 325a of the upper bag cavity 325. The upper closure portion 320 furthermore includes at least one aperture 319 formed in the upper closure portion 320 providing at least one passageway extending between the upper bag cavity 325 and an exterior of the upper closure portion 320. In an embodiment, the at least one aperture 319 is a pair of apertures 319. The at least one passageway is configured so that the at least one inlet line 330 and/or outlet line 340 extends through the at least one passageway from the upper bag cavity 325 to the exterior of the upper closure portion 320. The bag adapter 300 encloses the flexible bag 350 when the lower bag receptacle portion 310 and the upper closure portion 320 are joined together. In an embodiment, the lower bag receptacle portion 310 and the upper closure portion 320 define an overlap joint 318 at a juncture of the lower bag receptacle portion 310 and the upper closure portion 320 when the lower bag receptacle portion 310 and the upper closure portion 320 are joined together. In an embodiment, the top wall 321 of the upper closure portion 320 includes a rounded shoulder 326 that joins the circumferential upper side wall 324 of the upper closure portion 320. In an embodiment, the at least one aperture 319, or pair of apertures 319 shown in FIGS. 7 and 8, is formed in the rounded shoulder 326 of the upper closure portion 320. In an embodiment, the circumferential upper side wall 324 of the upper closure portion 320 is circular in transverse cross section. In an embodiment, the upper closure portion 320 is releasably joined to the lower bag receptacle portion 310.

The upper closure portion 320 includes an exterior surface that conforms to the arcuate wall 230 of the annular crown body 210. During operation of the centrifuge, the arcuate wall 230 of the annular crown body 210 is adjacent to the exterior upper closure portion 320 surface such that each of these components prevents the unintended movement of the other.

With continued reference to FIG. 8, the disassembled bag adapter 300 shows the lower bag receptable portion 310 including a rim 312 defining the opening 315a. The opening 315a has an inner sidewall surface forming the lower bag cavity 315, the lower bag cavity 315a sized to enclose at least a lower portion 352 of the flexible bag 350. Furthermore, the disassembled view of the bag adapter 300 also shows an upper closure portion 320 having a rim 322 having an inner edge defining an opening 325a. The opening 325a has an inner sidewall surface forming a upper bag cavity 325, the upper bag cavity 325 is sized to enclose at least an upper portion 354 of the flexible bag 350. The rim 322 has an outer edge defining an annular perimeter of the rim 322. The upper closure portion 320 further includes an outer sidewall surface extending from the outer edge to a ledge 370, the ledge 370 extending radially in relation to the rim 322. The upper closure portion 320 further includes at least one aperture 319 (shown in FIG. 8 as a pair of apertures) providing at least one passageway between an interior of the upper closure portion 320 and the exterior of the upper closure portion 320. The apertures 319 are sized to accept the inlet line 330 or the outlet line 340, or both if at least two apertures are provided, therethrough. The rim 312 of the lower bag receptacle portion 310 is configured to meet the ledge 370 when the lower bag receptable portion 310 is joined with the upper closure portion 320 (shown in FIG. 7) to form an overlap joint 318.

As described above, FIG. 8 shows two apertures 319 included on the upper closure portion 320. However, in some embodiments, there may be more than two apertures 319 or fewer than two apertures 319 in the upper closure portion 320. Furthermore, as shown in FIG. 8, the ledge 370 is shown extending radially outward in relation to the rim 322. However, it is contemplated that the ledge 370 may extend radially inward in relation to the rim 322 in the alternative or in addition to extending radially outward in relation to the rim 322.

In some embodiments, the bag adapter 300 is intended to be a single-use adapter, and accordingly, the flexible bag 350 is enclosed within both the lower bag receptable portion 310 and the upper closure portion 320, and the lower bag receptable portion 310 and the upper closure portion 320 are configured to be irreversibly joined together once the flexible bag 350 is enclosed within the lower bag cavity 315 and the upper bag cavity 325 of the lower bag receptable portion 310 and the upper closure portion 320, respectively. Alternatively, the bag adapter 300 may be intended to be a multiple-use adapter, and accordingly, the flexible bag 350 is enclosed within both the lower bag receptable portion 310 and the upper closure portion 320, and the lower bag receptable portion 310 and the upper closure portion 320 are configured to be removably joined together once the flexible bag 350 is enclosed within the lower bag cavity 315 and the upper bag cavity 325 of the lower bag receptable portion 310 and the upper closure portion 320, respectively. The lower bag receptable portion 310 will be coupled to the upper closure portion 320 during operation of the centrifuge, but the lower bag receptable portion 310 may be removed from the upper closure portion 320 before or after centrifugation.

As explained above, the lower bag receptable portion 310 and the upper closure portion 320 are two-pieces of the bag adapter 300. The lower bag receptable portion 310 or the upper closure portion 320, individually or in combination, may be made of metal, plastic, or polymer. Specific examples of suitable materials for the lower bag receptable portion 310, the upper closure portion 320, or both is polycarbonate.

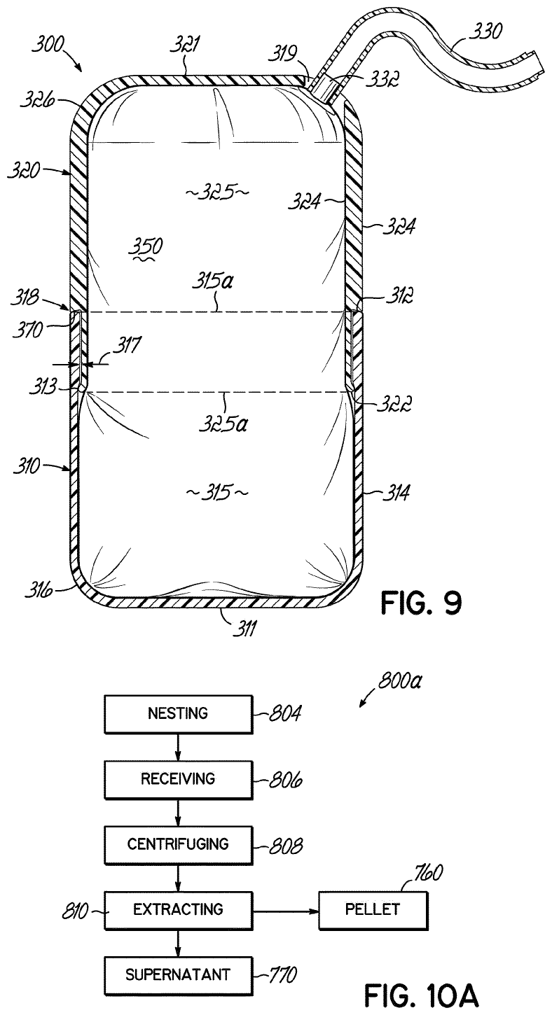

With reference to FIG. 9, a cross-section of the assembled bag adapter 300 including the flexible bag 350 enclosed therein is shown. The flexible bag 350 includes a port 332 for either an inlet line 330 or an outlet line 340 to be coupled thereto. The port 332 is configured to attach to the inlet line 330 and/or the outlet line 340. The attachment of the port 332 to the inlet line 330 and/or the outlet line 340 form a seal such that species outside the inlet line 330, outlet line 340, or interior of the flexible bag 350 are incapable of interacting with species within these areas.

With continued reference to FIG. 9, the upper closure portion 320 and the lower bag receptacle portion 310 are shown coupled together and nesting the flexible bag 350. At least prior to centrifuging the bag adapter 300, a clearance 317 may be present between the circumferential upper side wall 324 and the circumferential lower side wall 314. During centrifugation, the contents of the flexible bag 350 may apply a pressure on the interior side of the circumferential upper side wall 324, which reduces the clearance 317 between the circumferential upper side wall 324 and the circumferential lower side wall 314, such that the clearance 317 distance becomes close to, or exactly, zero meters. Furthermore, a lip 313 flares radially outward and includes the rim 322. The lip 313 is configured to slide over the circumferential lower side wall 314 when the bag adapter 300 is assembled. When the bag adapter 300 is assembled, the lip 313 frictionally engages with the circumferential lower side wall 314, and, in some embodiments, the frictional engagement of the lower circumferential side wall 314 with the lip 313 may inhibit the axial movement and/or separation of the upper closure portion 320 and the lower bag receptacle portion 310.

The centrifuge rotor 400 according to the present invention and the crown assembly 200 used therein enable centrifugation of bag adapters 300 having flexible bags 350 enclosed therein. Furthermore, inlet lines 330 and/or outlet lines 340 protruding outward from the flexible bags 350 assist in centrifuging the liquid suspension 700 without having to take special measures such as disconnecting the inlet lines 330 or outlet lines 340. Flexible bags 350 that can be centrifuged with the aid of the centrifuge rotor 400 according to the present invention in some examples include, but are not limited to, the following: a film bag in which one end of the film bag is sealed, in particular glued or welded; an arrangement of a plurality of film bags, in each of which one end of at least one film bag is sealed, in particular glued or welded, wherein the other ends of the film bags are connected to one another. In particular, flexible bag systems can be centrifuged which are described in International Patent Application Publication No. WO2019/166998A1. Reference is hereby expressly made to these two patent applications and their content is hereby incorporated into this application by reference. The flexible bags 350 described can be filled together with a tube assembly that may be branched, in series, or some combination thereof. The flexible bags 350 may be placed either individually or in groups into the bag adapters 300, which are then in turn placed in sample receptacles 410 of the centrifuge rotor 400 according to the present invention. The inlet lines 330 and outlet lines 340 which protrude upward from the flexible bags 350 and may still be connected to one another as they are brought to the crown assembly 200 and, as already described above, are fixed there by means of pressure from the crown assembly 200. This pressure contact of the crown assembly 200 to the bag adapter 300 occurs from the arcuate wall 230 of the annular crown body 210 to the upper closure portion 320 of the bag adapter 300. After the centrifugation process is complete, the flexible bags 350 may be removed from the bag adapter 300 and sent for further processing.

FIGS. 10A-10C show flowcharts for embodiments of a method 800a-800cof clarifying a liquid suspension 700. In an embodiment, the method 800a-800c includes nesting 804 a flexible bag 350 in a bag adapter 300, for example in the lower bag cavity 315 of the lower bag receptacle portion 310. The flexible bag 350 may or may not be filled or even partially filled with the fluid suspension 700 prior to, during, or after any of the nesting 804 step occurs. That is, the upper portion 354, lower portion 352, both the upper portion 354 and the lower portion 352, or neither the upper portion 354 or the lower portion 352 of the flexible bag 350 may be enclosed by the upper closure portion 320 or the lower bag receptacle portion 310, respectively, when the liquid suspension 700 is received 806 by the flexible bag 350.

The method 800a-800c further includes receiving 806 a liquid suspension 700 including a first material, and a second material suspended therein via an inlet line 330 into at least one flexible bag 350. The method 800a-800c further includes centrifuging 808 the bag adapter 300 including the at least one flexible bag 350 and the liquid suspension 700 in a centrifuge forming a supernatant fluid 770 (for example as shown in FIG. 11K) and a pellet 760 (for example as shown in FIG. 11K) in the at least one flexible bag 350, wherein the supernatant fluid 770 includes primarily the first material, and the pellet 760 includes primarily the second material. The method 800a-800c further includes extracting 810 the supernatant fluid 770 from the at least one flexible bag 350 via an outlet line 340. In some examples, the method 800a-800c may be performed in an entirely closed system. Accordingly, it is possible to conduct the method 800a-800c without exposing any of the liquid suspension 700, the supernatant fluid 770, or the pellet 760 to any contaminating species outside of the system. Each of the steps of the method 800a-800c will be described in more detail below.

The methods 800a-800c of the present invention are particularly useful in either the development of a bioprocessing method for using eukaryotic cells (such as CHO cells) to produce a recombinant protein product at a developmental scale (such as 10, 50, or 200 liter scale). They are also useful for quality control or other purposes of bioprocessing at a larger scale (such as 500, 1000, or 2000 liters). With reference to FIG. 10B, a flowchart of an embodiment of a method 800b of clarifying a liquid suspension 700 is shown. FIG. 10B includes a harvest step 801B occurring prior to the liquid suspension 700 being received 806 by the flexible bag 350. In some embodiments, the harvest step 801B includes growing or receiving cells suspended in a liquid phase or a medium having a product of interest in a liquid phase and directed through a manifold to a first set of bags or other containers, each being for example 1.0, 1.6, or 2 liter in size. The bag or other containers are configured to contain the liquid phase and are able to be centrifuged. The harvest step 801B may further include centrifuging, for example using a swinging bucket rotor at a speed of between 500 and 5000 rpm, the bags or other containers including the liquid phase to separate intact cells, which form a pellet during centrifugation, from a first supernatant. The pellet in the harvest step 801B includes primarily intact cells while the first supernatant includes primarily cell fragments. The harvest step 801B may further include recovering the first supernatant from the bag or other container, effectively separating the first supernatant from the pellet. That first supernatant from such a first set of bags may be collected in a common bag (using, for example, a method described in International Application Publication No. WO2019/166998A1), and then received 806 by the flexible bag 350 as the liquid suspension 700 described above in the receiving step 806, and other steps of the clarification method 800b process, described herein, occur subsequently.

Regarding the harvest step 801B, the common bag used to collect the first supernatant from the first set of bags may be fabricated with tubing attached at its outlet to the inlet of a manifold to feed the second set of bags. That combination of the common bag (with associated inlet and outlet tubing), manifold, second bags and related tubing may be subjected to radiation sterilization after assembly, within at least one outer bag or container used to store the combination and transport it to the site of intended use.

With reference to FIG. 10C, a flowchart of another embodiment of a method 800c of clarifying a liquid suspension is shown. FIG. 10C includes at least the same steps as the embodiment shown in FIG. 10B and described above. However, FIG. 10C further includes a lysis step 801C occurring after the harvest step 801B and before receiving 806 the liquid suspension by the flexible bag 350. The lysis step 801C allows for the collection of desired product which may inadvertently or otherwise be pelletized during the harvest step 801B. For example, some cells that are pelletized during the harvest step 801B may keep desired products inside the cells. To extract the product that may be within the cells, a lysis step 801C is performed. For methods 800c where a lysis step 801C is performed, after the first supernatant is removed from the bag or other container, the pellet, as produced during the harvest step 801C, is exposed to a chemical compound, or lysis buffer, such as CytoBuster™ Protein Extraction Reagent manufactured by Novagen®, Inc., located in Arkansas, USA 601 Science Drive or Madison, Wisconsin, USA 53711. The chemical compound is configured to break down contents within the pellet into a lysis liquid phase. Alternatively or in addition, the pellets are exposed to high pressures to break down the cells. The chemical compound and/or the high pressure exposure is configured to destroy, puncture, or otherwise pierce cell membranes or cell walls included in cells that make up the pellet. The lysis process may be particularly effective at breaking down cells that have cell walls, such as prokaryotic cells. Accordingly, the lysis liquid phase includes cell debris or particulate that is less whole and/or structurally stable than the cells that were previously included in the pellet immediately after the harvest step 801B at least because the cell membranes and/or cell walls of these cells have been compromised. The lysis liquid phase, in addition to the first supernatant from the harvest step 801B, is then received 806 into the flexible bag 350 as the liquid suspension 700 described above in the receiving step 806, and other steps of the clarification method 801C, described herein, occur subsequently.

With reference to FIGS. 11A-11K, FIGS. 11A and 11B show a flexible bag system which, in the example shown, has three flexible bags 350 shown as film bags, however any number or type of flexible bags 350 as described herein may be used in the flexible bag system. Each of the flexible bags 350 has been nested within a lower bag receptable portion 310 of a bag adapter 300, and connected to a manifold 750. The nesting step 804 includes placing at least one flexible bag 350 in a lower bag receptable portion 310 of a bag adapter 300. The nesting step 804 may occur either before or after the liquid suspension 700 has been received into the flexible bag 350 in the receiving step 806 (FIG. 11A shows that the flexible bags 350 have already been nested in the lower bag receptable portion 310 of the bag adapters 300 prior to receiving 806 the liquid suspension 700, but this is merely an example). It may be advantageous to nest the flexible bag 350 within the lower bag receptable portion 310 of the bag adapter 300 prior to the flexible bag 350 receiving the liquid suspension 700 to ease in the handing of the flexible bag 350.

The clarification method 800a-800c may include a harvest step 801B or a lysis step 801C prior to at least the receiving step 806. As described above, the harvest step 801B includes, in a closed system, for example, a reaction or a growth of cells in a harvest step liquid suspension in which cell debris, particulate, or other material is suspended in the harvest step liquid suspension. In some examples, the harvest step liquid suspension is the first material referred to above with reference to the liquid suspension 700, and the cell debris, particulate, or other material is the second material referred to above with reference to the liquid suspension 700. At least one of the goals of the process described herein is to clarify the liquid suspension 700 such that the first material and the second material are substantially, if not completely, separated. The harvest step 801B may include centrifuging the liquid suspension 700, in a closed system, prior to the liquid suspension's receipt into the flexible bag 350 described herein. The centrifugation process included in the harvest step 801B occurs at a much lower rpm/g-force than the centrifugation step 808 described below that occurs during clarification of the liquid suspension 700. For example, the harvest step 801B may include centrifuging a harvest liquid suspension at a rate of between 500 and 10,500 rpm which may exert up to, for example, 7,000 times the force of gravity on the harvest liquid suspension. The centrifuge during the harvest step 801B may operate for between 20 minutes and 40 minutes, with a preferred embodiment operating for 30 minutes, or until relatively large debris has been pelletized from the harvest liquid suspension to the satisfaction of an operator. In some embodiments, centrifugation during the harvest step 801B is carried out at a temperature between 4° C. and 20° C. At least because during the harvest step 801B the centrifuge operates at a much lower rpm and g-force than the centrifuge during the clarification method, only relatively large debris suspended in the harvest liquid suspension is pelletized. Accordingly, the harvest liquid suspension is separated into a harvest pellet and a harvest supernatant fluid, and the harvest supernatant fluid may eventually be fed into the liquid suspension container 730 as the liquid suspension 700 to be used in the clarification method. It is advantageous to perform the clarification method described herein after the initial harvest step 801B to remove large debris from the liquid suspension.

With continued reference to FIGS. 11A and 11B as well as FIGS. 10A-10C, the method 800a-800c includes receiving 806 the liquid suspension 700 including the first material and the second material. The first material and the second material are different materials having different densities and are configured to be separated by centrifugation, specifically by high rpm/high g-force centrifugation, referred to herein as clarification. In some examples, the liquid suspension 700 is a product from a reaction and/or growth of cells from a previous growth/reaction step. For example, the liquid suspension 700 may include a cell media including whole cells, cell debris, RNA, DNA, proteins, and/or combinations thereof. The first material may include cell debris or whole cells and the second material may include RNA, DNA, proteins (host cell secreted biologic product), and combinations thereof or any two suitable materials that are configured to separate from each other as a result of clarification.

With continued reference to FIGS. 11A and 11B, each of the flexible bags 350 has two connections, an inlet line 330 and an outlet line 340, shown in FIGS. 11A and 11B as an inlet tube and an outlet tube. The inlet lines 330 are configured to allow for the filling of the flexible bags 350 with the liquid suspension 700, for example during the receiving step 806, and, during the receiving step 806 as shown in FIGS. 11A and 11B, are each in mass communication with a manifold 750. The manifold 750 may be connected to a vacuum pump 740 which may assist in either drawing in the liquid suspension 700, for example from a previous lysis step 801C, or removing supernatant fluid 770 from the flexible bag 350 after the centrifugation step 808 as described herein, and shown in FIGS. 11K and 11L. Other pumps 740 may be used alternatively or in addition to the vacuum pump 740 to assist in addition or removal of the liquid suspension 700 or supernatant fluid 770, respectfully, from the flexible bag 350. One or more pumps 740 may be in-line with the manifold 750 (as shown in FIGS. 11A and 11B), and/or one or more pumps 740 may be a peristaltic pump. In a preferred embodiment, a peristaltic pump is used to direct the liquid suspension 700 into the flexible bag 350 to further ensure that the method 800a-800c remains performed in a closed system. Alternatively, the flexible bags 350 may be filled without the use of a pump 740 at all, but rather gravity may act on the liquid suspension 700 included in the liquid suspension container 730 container 730 and distribute the liquid suspension 700 through the manifold 750 into each flexible bag 350 connected thereto.

Other orientations of connections are possible as well. For example, while FIGS. 11A and 11B show a connection of flexible bags 350 in series to the manifold 750, the flexible bags 350 may alternatively be arranged in parallel (not shown), or in a branched arrangement (not shown). For a more detailed description of the filling process and further details on the flexible bag 350 system and the individual flexible bags 350, reference is again made to International Patent Application Publication No. WO2019166998A1.

With further reference to FIGS. 11A and 11B, clips 754 may be included on the inlet lines 330 to control when each individual flexible bag 350 is filled. The clips 754 may have an open position and a closed position. With reference to FIG. 11A, all clips located on the inlet lines 330 are in the open position, allowing liquid suspension 700 to travel through the inlet line 330. As shown in FIG. 11A, each flexible bag 350 has not yet received any amount of liquid suspension 770. As the receiving step 806 occurs, and the liquid suspension 700 is either pumped or otherwise directed through the manifold 750, and inlet lines 350 having clips 754 in the open position will be filled with liquid suspension 700. By moving a clip 754 into a closed position, the inlet line 330 is pinched closed, preventing further liquid suspension 700 from entering the flexible bag 350. For example, FIG. 11B shows that two clips on inlet lines 330 have been closed and the liquid suspension 700 is being transported from the liquid suspension container 730 into the only flexible bag 350 having a clip 754 in the open position on the inlet line 330. Accordingly, the distribution of the liquid suspension 700 from the liquid suspension container 730 may be controlled during the receiving step 806.

In some examples, the flexible bags 350 are weighed as the flexible bags 350 receive liquid suspension 700. In an example, the flexible bags 350 are placed on a rack 900 which is placed on a scale 910 to determine when the flexible bags 350 are properly filled. Flexible bags 350 nested within the lower bag receptable portion 310 of the bag adapter 300 may be placed on the rack 900 and weighed prior to the liquid suspension 700 being received by the flexible bag 350, and continued to be weighed throughout the receiving step 806. FIG. 11C shows several flexible bags 350 nested within lower bag receptable portion 310s of bag adapters 300 each being weighed simultaneously on a scale 910 prior to the flexible bag 350 receiving any liquid suspension 700. Any or all flexible bags 350 nested within the lower bag receptable portion 310 of the bag adapter 300 may be placed on the rack 900 and weighed during this process. As shown in FIG. 11D, each flexible bag 350 nested within a lower bag receptable portion 310 of the bag adapter 300 may be weighed continuously as liquid suspension 700 is added thereto from the liquid suspension container 730 container 730. Any liquid suspension 700 that is desired to enter any individual flexible bag 350 may do so if the clip 754 located on the inlet line 330 is placed in the open position, and additional liquid suspension 700 is directed into any individual flexible bag 350, as desired. When the flexible bag 350 is sufficiently full, the clip 754 may be closed, preventing further liquid suspension 700 from entering the flexible bag 350. In some embodiments, the flexible bags 350 are filled until each flexible bag 350 includes between 0.5 kg and 1.5 kg of liquid suspension 700. In a preferred embodiment, the flexible bags 350 are filled until each flexible bag 350 includes about or exactly 0.9 kg of liquid suspension 700. At the end of the receiving step 806, each flexible bag 350 will include approximately the same amount of liquid suspension 700, regardless of the exact mass of liquid suspension 700 received.

This is to ensure that the centrifuge rotor 400 is balanced during the centrifugation step 808. In some embodiments, flexible bags 350 having liquid suspension 700 therein may weigh within 50 grams of each other in order to ensure that the centrifuge rotor 400 is balanced when the flexible bags 350 are eventually loaded into the centrifuge rotor 400.

In order to separate a first material from a second material in the liquid suspension 700, the flexible bag 350 with the liquid suspension 700 contained therein may be centrifuged. The flexible bags 350 are first separated from a liquid suspension container 730. The separation of the flexible bag 350 from the liquid suspension container 730 occurs by severing the inlet line 330 from the manifold 750, and takes place after the flexible bag 350 has been filled. With reference to FIGS. 11E and 11F, the inlet line 330 is severed from the manifold 750, for example by a welding machine 920. In some examples, the welding machine 920 is a TERUMOR SCD® iiB Sterile Tubing Welder, but other welding machines 920 are suitable. Any welding machine 920 that is capable of severing the inlet tube 330 connection to the manifold 750 while maintaining the closed system within the flexible bag 350 is suitable. FIG. 11E shows the inlet tube 330 being inserted into the welding machine 920. In some examples, as shown in FIG. 11F, the inlet tube 330, after having been severed from the manifold 750, may be folded over onto itself and capped with a cap 710 to maintain the closed system within the flexible bag 350. The cap 710 may be placed and secured on a folded-over end of the inlet tube 330 to prevent to the unfolding of the inlet tube 330 end. Then, with reference to FIG. 11G, the upper closure portion 320 of the bag adapter 300 is placed over the flexible bag 350 and joined with the lower bag receptable portion 310, thus enclosing the flexible bag 350 within the bag adapter 300. The inlet line 330 and the outlet line 340 are lead through the apertures 319 included through the upper closure portion 320 as the upper closure portion 320 is placed onto the lower bag receptable portion 310.

With reference to FIG. 11H, during the centrifugation step 808, the bag adapters 300, with the flexible bags 350 enclosed therein, are placed in individual receptacles 410 of the centrifuge rotor 400. The bag adapters 300 enclosing the flexible bags 350 are individually weighed prior to their placement into the centrifuge, as described above. Each of the bag adapters 300 enclosing the flexible bags 350 are placed in the centrifuge rotor 400 in receptacles 410 opposite from similarly weighted bag adapters 300 in order to balance the centrifuge rotor 400 and assist in the centrifugation step 808. The crown assembly 200, as discussed above, is then placed over the bag adapters 300 with each upper closure portion 320 of the bag adapters 300 having a surface that conforms to, and meets, an arcuate wall 230 of the annular crown body 210. The inlet lines 330 and the outlet lines 340 are lead through the apertures 232, into the crown cavity 216. FIG. 11I shows the crown assembly 200, properly placed, and the inlet lines 330 and outlet lines 340 arranged within the crown cavity 216 of the annular crown body 210. The crown ring 220 is then placed over the inlet lines 330 and outlet lines 340 with a portion of the crown ring 220 extending radially inward from the perimeter of the rim 212 of the annular crown body 210. The crown ring 220 includes an annular side wall 224 having O-ring receptacles 226 thereon. The crown ring 220 is secured in place and at least partially supported by the circumferential side wall 233 of the annular crown body 210 when O-rings 219 located on and protruding the circumferential side wall 233 of the annular crown body 210 are positioned within the O-ring receptacles 226 on the annular side wall 224 of the crown ring 220. The O-ring receptacle 226 prevents movement of the crown ring 220 by physical interaction with the O-rings 219, and accordingly, the crown ring 220 is coupled to the annular crown body 210. The annular lip 222 of the crown ring 220 secures the inlet lines 330 and outline lines 340 within the crown cavity 216 of the annular crown body 210.

The centrifuge is then closed with its lid 450, and a centrifugation step 808 then occurs. During the centrifugation step 808, the centrifuge may operate at rotation speeds of between 500 and 10,500 rpm. In a preferred embodiment, and to promote the clarification of relatively small cell debris and particle contaminants included in the liquid suspension 700, such as cell debris and/or particles of less than or equal to 1 micron in size, the centrifuge may operate at rotation speeds of greater than or equal to 5,000 rpm, such as between 5,000 and 10,500 rpm, preferably between 6,000 and 10,500 rpm, and more preferably between 8,000 and 10,500 rpm. Furthermore, these high rotation speeds may result in high g-forces being exerted on the liquid suspension 700, the flexible bag 350, and/or the bag adapter 300. These g-forces may amount to greater than or equal to 7,000 times the force of gravity, such as between 7,000 and 21,000 times the force of gravity. In a preferred embodiment, the g-forces amount to between 9,000 and 21,000 times the force of gravity, and more preferably between 15,000 and 20,584 times the force of gravity. In some examples, the centrifugation step 808 may occur for between 5 minutes and 15 minutes, preferably between 8 minutes and 12 minutes, and most preferably for 10 minutes. The temperature of the centrifugation step 808 inside the centrifuge is maintained at between 15° C. and 25° C., preferably between 17° C. and 23° C., and most preferably at 20° C. At the end of the centrifugation step 808, small debris and particulate that was suspended in the liquid suspension 700 will have pelletized into a pellet 760, and the liquid suspension 700 will be separated within the flexible bag 350 into the pellet 760 and a supernatant fluid 770. FIG. 11J shows the flexible bag 350 within the centrifuge rotor 400 at the end of the centrifuge step 808.

As used herein, “high rpm” is intended to refer to centrifugation that occurs at greater than or equal to 5,000 rotations per minute. “High g-force centrifugation” is intended to refer to centrifugation that occurs at greater than or equal to 7,000 g (7,000 times the force of gravity on the earth).

With reference to FIG. 11K, in an extracting step 810, after the centrifugation step 808, the bag adapters 300 are removed from the centrifuge. The contents of the flexible bags 350 are examined without opening the flexible bags 350 to see if a pellet 760 and supernatant fluid 770 have formed. If the pellet 760 and supernatant fluid 770 have formed, the flexible bags 350 are coupled to another manifold 750, similar to the manifold 750 used in the receiving step 806. The manifold 750 used in the extracting step 810 may be the same or different manifold used in the receiving step 806, however to maintain purity of the supernatant fluid 770, and to avoid reintroduction of liquid suspension 700 into the supernatant fluid 770, it is preferred to use a new manifold 750 rather than reuse the manifold 750 from the receiving step 806. Outlet lines 340 are coupled to the extracting manifold 750, which may be in communication with one or more pumps 740. The pump 740 may be in-line with the manifold 750 and include, for example, a vacuum pump 740 or other pump system. Alternatively, or in addition, one or more pumps 740 may be a peristaltic pump, and direct supernatant fluid 770 from the flexible bag 350 without being directly in-line with the manifold 750.

With further reference to FIG. 11K, clips 754 may be included on the outlet lines 340 to control when each individual flexible bag 350 has the supernatant fluid extracted therefrom. The clips 754 may have an open position and a closed position. With reference to FIG. 11K, all clips 754 located on the outlet lines 340 are in the open position, allowing liquid suspension 770 to travel through the outlet line 340. As shown in FIG. 11K, each flexible bag 350 has not yet had any supernatant fluid 770 extracted therefrom. As the extracting step 810, and the supernatant fluid 770 is either pumped or otherwise directed through the outlet lines 340 having a clip 754 in the open position, into the manifold 750, and eventually into a storage container 720. By moving a clip 754 into a closed position, the outlet line 340 is pinched closed, preventing further supernatant fluid 770 from exiting the flexible bag 350. For example, FIG. 11K shows that two clips 754 on outlet lines 340 have been closed and the supernatant fluid 770 is being transported from the flexible bag 350 having a clip 754 in the open position on the outlet line 340 into the storage container 720. Accordingly, the extraction of the supernatant fluid 770 from the flexible bags 350 may be controlled during the extracting step 810.

Alternatively from the pump 740 shown in FIG. 11K, the supernatant fluid 770 may be pressed out of the flexible bag 350 via an expressor 930. After the flexible bag 350 has been connected and is in mass communication with the manifold 750, the flexible bag 350 may be placed in an expressor 930 which presses the flexible bag 350, forcing the supernatant fluid 770 into the manifold 750 and eventually to the storage container 720, as shown in FIG. 11K. Once the supernatant fluid 770 is removed from the flexible bag 350, the supernatant fluid 770 may be sent for further processing or may be stored within the storage container 720 until needed.

The specific exemplifying embodiments of the present invention shown in figures and discussed above should not be construed as limiting. A person skilled in the art can amend and modify the embodiments in many evident ways within the scope of the attached claims. Thus, the present invention is not limited merely to the embodiments described above.

1. A bag adapter configured to enclose a flexible bag containing a liquid suspension and having at least one inlet line and/or outlet line fluidly coupled to the flexible bag, with the at least one inlet and/or outlet line extending from the flexible bag to an exterior of the bag adapter, the bag adapter comprising:
a lower bag receptacle portion configured to receive a lower portion of the flexible bag, the lower bag receptacle portion comprising:
a bottom wall; and
a circumferential lower side wall extending upwardly from the bottom wall and defining, with the bottom wall, a lower bag cavity having an opening located opposite the bottom wall and defined by a rim of the circumferential lower side wall, the lower bag receptacle portion at least partially enclosing the lower portion of the flexible bag when the lower portion of the flexible bag is received in the lower bag receptacle portion through the opening of the lower bag cavity; and
an upper closure portion configured to be joined to the lower bag receptacle portion and receive an upper portion of the flexible bag, the upper closure portion comprising:
a top wall;
a circumferential upper side wall depending from the top wall and defining, with the top wall, an upper bag cavity having an opening located opposite the top wall and defined by a rim of the upper side wall, the upper closure portion at least partially enclosing the upper portion of the flexible bag when the upper portion of the flexible bag is received through the opening of the upper bag cavity; and
at least one aperture formed in the upper closure portion providing at least one passageway extending between the upper bag cavity and an exterior of the upper closure portion, the at least one passageway being configured so that the at least one inlet line and/or outlet line extends through the at least one passageway from the upper bag cavity to the exterior of the upper closure portion, with the bag adapter enclosing the flexible bag when the lower bag receptacle portion and the upper closure portion are joined together.

2. The bag adapter of claim 1, wherein;
the at least one aperture comprises a pair of apertures;
the lower bag receptacle portion and the upper closure portion define an overlap joint at a juncture of the lower bag receptacle portion and the upper closure portion; or
the bottom wall of the lower bag receptacle portion includes a rounded shoulder that joins the circumferential lower side wall of the lower bag receptacle portion.

3. (canceled)

4. (canceled)

5. The bag adapter of claim 1, wherein the top wall of the upper closure portion includes a rounded shoulder that joins the circumferential upper side wall of the upper closure portion, wherein the at least one aperture is formed in the rounded shoulder of the upper closure portion, and wherein a pair of apertures is formed in the rounded shoulder of the upper closure portion.

6. (canceled)

7. (canceled)

8. The bag adapter of claim 1, wherein:
the circumferential lower side wall of the lower bag receptacle portion is circular in transverse cross section;
the circumferential upper side wall of the upper closure portion is circular in transverse cross section; or
the upper closure portion is releasably joined to the lower bag receptacle portion.

9. (canceled)

10. (canceled)

11. A crown assembly for use with a rotor to at least partially enclose at least one inlet line and/or outlet line fluidly coupled to at least one flexible bag containing a liquid suspension during centrifugation of the at least one flexible bag in the rotor, the crown assembly comprising:
an annular crown body defining a crown cavity and comprising:
a bottom wall;
a circumferential side wall spaced upwardly from the bottom wall;
a circumferential scalloped side wall extending between the bottom wall and the circumferential side wall, the circumferential scalloped side wall including a plurality of radially inwardly directed arcuate walls disposed circumferentially about the circumferential scalloped side wall;
at least one aperture formed in each of the plurality of radially inwardly directed arcuate walls providing at least one passageway extending between an exterior of the annular crown body and the crown cavity, the at least one passageway being configured so that the at least one inlet line and/or outlet line may extend through the at least one passageway from the exterior of the annular crown body to the crown cavity; and
an annular mount extending upwardly from the bottom wall and being disposed centrally within the annular crown body;
a resilient element supported by the annular mount;
a crown assembly plunger operatively engaging the resilient element and being moveable vertically relative to the annular mount between first and second positions, the resilient element biasing the crown assembly plunger to the first position, the crown assembly plunger being movable to the second position in response to compression of the resilient element by a lid of the rotor; and
an annular crown ring removably joined to the annular crown body and being configured, with the annular crown body, to at least partially enclose the at least one inlet line and/or outlet line fluidly connected to the flexible bag within the crown cavity during centrifugation of the at least one flexible bag in the rotor.

12. The crown assembly of claim 11, wherein the annular crown ring comprises an annular side wall and an annular lip extending radially inwardly from the annular side wall of the annular crown ring, or wherein the at least one aperture comprises a pair of apertures.

13. The crown assembly of claim 12, wherein;
the annular lip extends radially inwardly and downwardly from the annular side wall of the annular crown ring:
the annular lip is at least partially translucent; or
the annular crown ring is mounted in the crown cavity.

14. (canceled)

15. (canceled)

16. The crown assembly of claim 11, further comprising at least one O-ring supported by the annular side wall of the annular crown ring and being configured to engage the circumferential side wall of the annular crown body when the annular crown ring is mounted in the crown cavity.

17. The crown assembly of claim 12, further comprising a carbon fiber reinforcement disposed about the annular side wall of the annular crown ring.

18. The crown assembly of claim 11, wherein the at least one aperture comprises a pair of apertures.

19. The crown assembly of claim 11, wherein the annular mount comprises: an inner annular wall extending upwardly from the bottom wall; and
an outer annular wall extending upwardly from the bottom wall and being disposed concentrically about the inner annular wall to define a cavity between the inner and outer annular walls of the annular mount, with the cavity of the annular mount being configured to support the resilient element at least partially within the cavity of the annular mount.

20. The crown assembly of claim 19, wherein the crown assembly plunger comprises:
an annular body defining an annular shoulder;
an inner annular wall depending from the annular shoulder; and
an outer annular wall depending from the annular shoulder and being disposed concentrically about the inner annual wall to define a cavity between the inner and outer annular walls of the crown assembly plunger, with the cavity of the crown assembly plunger being configured to support the resilient element at least partially within the cavity of the crown assembly plunger.

21. The crown assembly of claim 11, wherein the crown assembly plunger is mounted for movement at least partially within the annular mount.

22. The crown assembly of claim 11, wherein the plurality of radially inwardly directed arcuate walls comprises four arcuate walls; or the plurality of radially inwardly directed arcuate walls comprises at least six arcuate walls.

23. (canceled)

24. A kit, comprising:
at least one bag adapter configured to enclose a flexible bag containing a liquid suspension and having at least one inlet line and/or outlet line fluidly coupled to the flexible bag, with the at least one inlet and/or outlet line extending from the flexible bag to an exterior of the bag adapter, the at least one bag adapter comprising:
a lower bag receptacle portion configured to receive a lower portion of the flexible bag, the lower bag receptacle portion comprising:
a bottom wall; and
a circumferential lower side wall extending upwardly from the bottom wall and defining, with the bottom wall, a lower bag cavity having an opening located opposite the bottom wall and defined by a rim of the lower side wall, the lower bag receptacle portion at least partially enclosing the lower portion of the flexible bag when the lower portion of the flexible bag is received in the lower bag receptacle portion through the opening of the lower bag cavity; and
an upper closure portion configured to be joined to the lower bag receptacle portion and receive an upper portion of the flexible bag, the upper closure portion comprising:
a top wall;
a circumferential upper side wall depending from the top wall and defining, with the top wall, an upper bag cavity having an opening located opposite the top wall and defined by a rim of the upper side wall, the upper closure portion at least partially enclosing the upper portion of the flexible bag when the upper portion of the flexible bag is received through the opening of the upper bag cavity; and
at least one aperture formed in the upper closure portion providing at least one passageway extending between the upper bag cavity and an exterior of the upper closure portion, the at least one passageway being configured so that the at least one inlet line and/or outlet line may extend through the at least one passageway from the upper bag cavity to the exterior of the upper closure portion, with the bag adapter enclosing the flexible bag when the lower bag receptacle portion and the upper closure portion are joined together; and
the crown assembly of claim 11.

25. The kit of claim 24, further comprising:
at least one flexible bag configured to contain a liquid suspension and having at least one inlet line and/or outlet line fluidly coupled to the flexible bag.

26. A method of clarifying a liquid suspension contained in at least one flexible bag having at least one inlet line and/or outlet line fluidly coupled to the flexible bag, the method comprising:
nesting the at least one flexible bag containing the liquid suspension within at least one bag adapter with the at least one inlet line and/or outlet line extending from the flexible bag to an exterior of the bag adapter;
at least partially enclosing the at least one inlet line and/or outlet line within a crown cavity defined by a crown assembly; and
centrifuging the at least one bag adapter and the at least one flexible bag containing the liquid suspension in a centrifuge to produce a supernatant fluid and a pellet in the at least one flexible bag.

27. The method of claim 26 further comprising the step of:
extracting the supernatant fluid from the at least one flexible bag via at least one outlet line fluidly coupled to the at least one flexible bag, wherein the at least one flexible bag is removed from the at least one bag adapter prior to the extraction step. wherein the supernatant fluid is extracted into in an outlet manifold via the at least one outlet line which is fluidly coupled to the flexible bag containing the liquid suspension, and wherein extracting the supernatant fluid from the at least one flexible bag comprises the supernatant fluid being extracted into a storage container or an outlet manifold.

28. (canceled)

29. The method of claim 26, further comprising: receiving the liquid suspension in the at least one flexible bag via at least one inlet line, wherein the at least one flexible bag is located at least partially outside of the at least one bag adapter when the liquid suspension is received in the at least one flexible bag, wherein the liquid suspension is received in the at least one flexible bag via the at least one inlet line which is fluidly coupled to a source of liquid suspension, and wherein an inlet manifold is fluidly coupled to the source of liquid suspension and to the at least one inlet line fluidly coupled to the at least one flexible bag.

30. (canceled)

31. (canceled)

32. (canceled)

33. The method of claim 26, wherein the bag adapter comprises:
a lower bag receptacle portion configured to enclose a lower portion of the flexible bag and an upper closure portion configured to enclose an upper portion of the flexible bag, the bag adapter being configured to withstand greater g-forces than the at least one flexible bag.

34. (canceled)

35. (canceled)

36. (canceled)

37. (canceled)

38. (canceled)

39. (canceled)

40. (canceled)
